(19) United States
(12) Patent Application Publication
(10) Pub. No.: US 2009/0011755 A1
(43) Pub. Date: Jan. 8, 2009

(54) Cellular System and Method

(76) Inventor: Zion Hadad, Rishon Le Zion (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/160,309

(22) PCT Filed: Jan. 10, 2007
(86) PCT No.: PCT/IL07/00041

§ 371 Date: Jul. 8, 2008

(30) Foreign Application Priority Data
Jan. 10, 2006 (IL) 173069

(51) Int. Cl. H04Q 7/20

(52) U.S. Cl. 455/422.1

(57) ABSTRACT

In a cellular wireless system with interference originating from other base stations, a system for reducing the interference comprises: a. in the SS, means for canceling the signals of one or more of k BSs; b. at each BS, repeatedly sending the same data k+1 times, coded with a biphase code and synchronized in time, to allow to constructively combine the transmissions from a desired BS while destructively combining the transmissions from the other BSs. A method for transmitting signals from a first base station (BS) to a subscriber station (SS), while reducing interference from adjacent BSs, comprising: A. Allowing no change over time, assuming the transfer function for relevant channels does not change; B. Keeping constant the data transmitted from relevant BSs, or transmitting the opposite/negative signals; C. Finding the data of each BS, by combining received signals.

### FIELD OF THE INVENTION

This invention relates to systems and methods for reducing interference in cellular wireless systems, and more particularly to reducing interference due to an adjacent base station.

### BACKGROUND OF THE INVENTION

When a SS is in the range of two or more BSs, the SS receives them at the same time and there is a need to identify the data of each of them or to cancel/reduce the effect of one or more BSs.

In standard 802.16 six repetitions can be defined, such as in FCH in order to use several signals and improve SNR using error correcting techniques in about 4 dB. This is especially important if FUSC is used, thus BS's share common channels/frequencies, and the capacity is reduced because of the large number of repetitions that might be required.

### SUMMARY OF THE INVENTION

The new method or system allows identifying and/or canceling the signals of one or more of k BSs, within a finite number of time steps and/or intervals and/or frames.

In case there are known pilot signals within each UL and/or DL transmission, these pilots allow learning about the transfer function h or Channel Impulse Response of the channel at about that time, thus better recognition of the signals might be possible, such as using an inverse of h (ĥ−1) or multiplying with its complex conjugate h′ and normalizing. The purpose is to cancel a channel's distortions as much as possible and to restore the original signal.

In case the pilots are not known, or do not change much in time and/or frequency and/or between intervals, then using the fact or assumption that the channel's behavior did not change too much, it might be possible to cancel or reduce the effect of other BSs.

In standard 802.16, pilots of each BS are unique at a preamble section of a frame. This invention can be useful for OFDM Orthogonal Frequency Division Multiplexing and OFDMA Orthogonal Frequency Division Multiple Access compatible systems, with LOS Line Of Sight, and for NLOS Non Line Of Sight systems too.

Some Benefits which may be achieved:
1. Transmit the same signal—may improve detection using MLD.
2. Compatible with standards—no need to change channels and/or bandwidth allocations to users and/or to transmit nonstandard signals.
3. Identify and detect signals of each BS.
4. Using only two cycles and saving resources, rather than using 6 cycles.
5. Useful for working in the presence of two or more BS's.
6. May help using FUSC instead of PUSC, thus increasing bandwidth/channels capacity.
7. May be implemented at the MAC level.

### 8. BRIEF DESCRIPTION OF THE DRAWINGS

FIG. 1 details a Subscriber Station receiving signals of two Base Stations at T1

FIG. 2 details a Subscriber Station receiving signals of two Base Stations at T2

FIG. 3 details signals received from two Base Stations at T1 and T2 with Initial Information

FIG. 4 details signals received from two Base Stations at T1 and T2 without Initial Information

FIG. 5 details Signal Spaces of two communication channels with different SNR

FIG. 6 Details Signal Spaces of a communication channels with one or more distortion effects

FIG. 7 details reception of a sum of signals from two channels in Signal Space

FIG. 8 details a system with two antennas for reducing interferences with MRC

FIG. 9 details detection of a strong signal with cancellation of a weak signal

FIG. 10 details a system for receiving signals from two channels using one FFT mechanism

FIG. 11 details a Feedback Sub-System used with the system of FIG. 10

FIG. 12 details a system for receiving signals from two channels using two FFT mechanisms

FIG. 13 details a Feedback Sub-System used with the system of FIG. 12

FIG. 14 details a system for receiving signals of two antennas using a wider spectrum

FIG. 15 illustrates a frequency spectrum of the signals of the system of FIG. 14

FIG. 16 details a system for receiving signals from four antennas using a wider spectrum with the same IF frequency

FIG. 17 details a system for receiving signals from four antennas using a wider spectrum with the same IF module

FIG. 18 illustrates frequency spectrums of the systems of FIGS. 16 and 17

FIG. 19 details usage of MUX for using four antennas

FIGS. 20-22 detail embodiments for using two antennas and separating I and Q.

FIG. 23 Details a system for shifting a complex signal using switching means.

FIGS. 24A-24D detail embodiments for combining two signals on one spectrum.

FIG. 25 details a system for combining two signals, each with I and Q.

FIGS. 26A-26E detail spectra of signals in the stages of sampling, shifting one signal and summing the signals.

### DETAILED DESCRIPTION OF THE INVENTION

The present invention will now be detailed by way of example and with reference to the accompanying drawings.

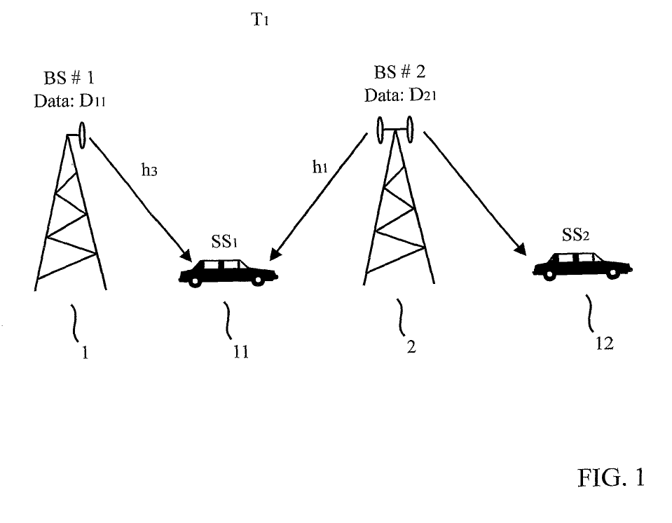

FIG. 1 details a Subscriber Station 11 receiving signals of two Base Stations 1 and 2 at T1 In case a Subscriber Station SS is not close to a Base Station BS, then it might be more difficult for the BS to communicate with a certain BS.

It is possible that Subscriber Station 11 SS1 would try to communicate with Base Station 1 BS#1 while Subscriber Station 12 SS#2 would try to communicate, or would communicate, with Base Station 2 BS#2 using some or all of the resources used by SS1.

SS1 and SS2 could use the same frequency and/or time resources, thus interfering with each other and reducing the efficiency of using resources.

In embodiments related to standard 802.16, PUSC or FUSC could be used. In Partial usage of subchannels, only some of the subchannels are allocated. While this may reduce interference, it would also limit the usage of bandwidth.

Full usage of subchannels (FUSC) may support using all of the subchannels, again facing the problem of handling unwanted signals of one or more BSs.

A SS may be a Mobile station, thus it can be in motion or may stop at unspecified points.

When referring to a BS, it may be also be any of the following:

Neighbor BS: For any MS, a neighbor BS is a BS (other than the serving BS) whose downlink transmission can be demodulated by the MS.

Serving BS: For any mobile station (MS), the serving BS is the BS with which the MS has most recently completed registration at initial network-entry or during an HO.

Target BS: The BS that an MS intends to be registered with at the end of a HO.

Active set: Active set is applicable to SHO and FBSS. The active set contains a list of active BSs to the MS. The active set is managed by the MS and BS.

Active BS: An active BS is informed of the MS' capabilities, security parameters, service flows and full MAC context information. For SHO, the MS transmits/receives data to/from all active BSs in the active set.

Anchor BS: For SHO or FBSS supporting MS, this is a BS where the MS is registered, synchronized with, performs ranging with and monitors the DL for control information. For FBSS supporting MS, this is the serving BS that is designated to transmit/receive data to/from the MS at a given frame.

In some systems, it may be possible to switch to other BS, such as by using handover. Hand Over (HO) is the process by which a MS migrates from the air-interface provided by one BS to the air-interface provided by another BS.

A break-before-make HO is a HO where service with the target BS starts after a disconnection of service with the previous serving BS.

A make-before-break HO: is a 110 where service with the target BS starts before disconnection of the service with the previous serving BS.

The Scanning interval, which is the time period intended for the MS to monitor neighbor BSs to determine the suitability of the BSs as targets for HO, may be critical time for the SS in order to correctly use resources for connecting to the BS.

A Soft Hand Over (SHO) is the process by which a MS migrates from the air-interface provided by one or more BS to the air-interface provided by other one or more BS. This process is accomplished in the DL by having two or more BSs transmitting the same MAC/PHY PDUs to the MS such that diversity combining can be performed by the MS. In the UL it is accomplished by having two or more BSs receiving (demodulating, decoding) the same PDUs from the MSS, such that diversity combining of the received PDUs can be performed among the BSs.

In some embodiments in this invention, communicating with the BSs is managed better with recognition of the BSs.

In this figure, at T1, the transfer function of BS#1 to SS1 is h3 and the transfer function of BS#2 to SS1 is h1.

It is possible that, on the relevant resources, BS#1 should communicate with SS1 and BS#2 should communicate with SS2.

In case SS1 would try to ignore BS#2 and would treat it as noise, the communication with SS1 might be poor.

It is possible to repeat data for several times, in order to improve SNR and use the signals of several transmissions to find data.

A preferred embodiment allow using only two repetitions in order to find the data of BS#1 at T1, which is D11 and the data of BS#2 at T1, which is D21. At the same time, it might be possible for BS#2 to communicate with SS2.

Thus, the signal received by SS1 at T1 is: Y(1)=D₁₁*h₃+D₂₁*h₁

Noise may be included as well, such as in practice.

The new method or system allows identifying the signals of each of k BS's, within k+1 time steps (or frames).

In a preferred embodiment, there are known pilot signals within UpLink UL and/or DL

DownLink transmissions. UpLink refers to transmissions from the SS to the BS and

Downlink to transmissions from the BS to the SS.

Pilot signals may allow learning the transfer function h of the channel at that time, thus better recognition of the signals might be possible, such as using an inverse of h(ĥ−1) or multiplying with its complex conjugate h′ and normalizing.

The purpose is to cancel channel's distortions as much as possible and to find original signals.

According to 802.16, Pilot signals of each BS can be at unique frequencies at a preamble section of a frame.

Transmission can be comprised of frames with a preamble in its start.

A DownLink MAP DL-MAP may include information about the transmission of the frame from the BS. Thus, the SS can learn what the BS is about to transmit and how to communicate from the DL-MAP, and learn the channel characteristics and additional information from the preamble.

Pilots are transmitted on different frequencies/channels. Pilots of each BS can be found and from them h between the BS and the SS can be calculated for the relevant data. Thus h1 . . . h4 are known. The purpose is to identify the data of the BS's D11 . . . D22.

In one embodiment, by using four pilots of each BS, it is possible to evaluate the remaining pilots with the aim of identifying them and correcting the data.

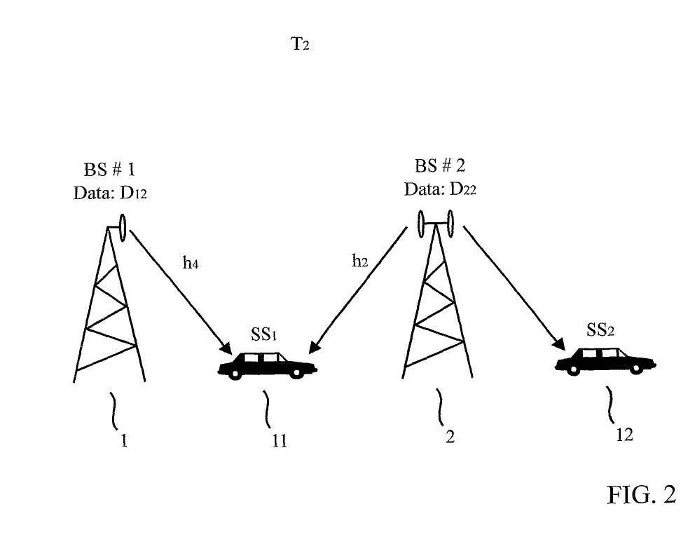

FIG. 2 Details the same Subscriber Stations of FIG. 1 receiving signals of the two Base Stations at T2. In T2 the transfer functions of BS#1 to SS1 is h4 and the transfer function of BS#2 to SS1 is h2.

In 802.16 the two signals are on the same channel. Can be implemented for QPSK, 16 QAM and 64 QAM as well.

The signal received by SS1 at T2 is: Y(2)=D₁₂*h₄+D₂₂*h₂

The complex conjugate of h1 would be marked as h1′ thus: : h₁′*h₁=|h₁|² and h₂′*h₂=|h₂|²

By performing multiplications using known functions and normalizing:

Y(1)*h₁′/|h₁|²=D₁₁*h₃*h₁′/|h₁|²+D₂₁

Y(2)*h₂′/|h₂|²=D₁₂*h₄*h₂′/|h₂|²+D₂₂
Data from BS#1 ̂ ̂Data from BS#2→canceled

In a preferred embodiment, it is possible to choose in the second interval to transmit:

D11=D12 (BS#1 keeps the same signal)
D21=−D22 (BS#2 transmits the opposite signal)

By doing so, BS#2 can continue communicating with SS2 and even improve the SNR with SS2, since repetitions of the data is implemented

A 3 dB improvement may be achieved.

Since the data of BS#2 is cancelled, SS1 can use this method to find the data of BS#1 more efficiently.

The result of adding the two signals Y(1) and Y(2) is:

Y=Y(1)+Y(2)=D₁₁*h₃*h₁′/|h₁|²+D₁₂*h₄*h₂′/|h₂|²

Y=Y(1)+Y(2)=D₁₁*(h₃*h₁′/|h₁|²+h₄*h₂′/|h₂|²)=D₁₁*h~

And where h~ is known. D11 can be found now:

D₁₁=Y*(h~)′/(h~)²

Since h˜ is known and D11 has been found, data from BS#2 can be found as well, such as by subtracting instead of adding Y(1) and Y(2), then reducing the known signals from BS#1 and remaining only with the signal of BS#2:

Y(1)*h₁′/|h₁|²−Y(2)′h₂′/|h₂|²=D₁₁*h₃*h₁′/|h₁|²+D₂₁−D₁₂*h₄*h₂′/|h₂|²−D₂₂

Knowing that:

D₁₁=D₁₂ (BS#1 keeps the same signal) and D11 has been found.
D₂₁=−D₂₂ (BS#2 transmits the opposite signal)

Which results in:

Y(1)*h₁′/|h₁|²−Y(2)′h₂′/|h₂|²+D₁₁*(h₃*h₁′/|h₁|²−h₄*h₂′|h₂|²)=−2*D₂₂

Hence the data of BS#2 can also be found.

It is possible to record one or more signals in order to use them for the calculations.

In another embodiment, the data is transmitted from one or more BSs, k+1 number of times for canceling transmissions of other k BSs. This may be useful such as in 802.16 for canceling signals of neighbor BSs.

In another preferred embodiment, other mathematical implementations can be done for getting the same result—canceling the effect of one or more BSs. In practice, the effect is not a complete cancellation, even though it is useful for improving BER and communication efficiency.

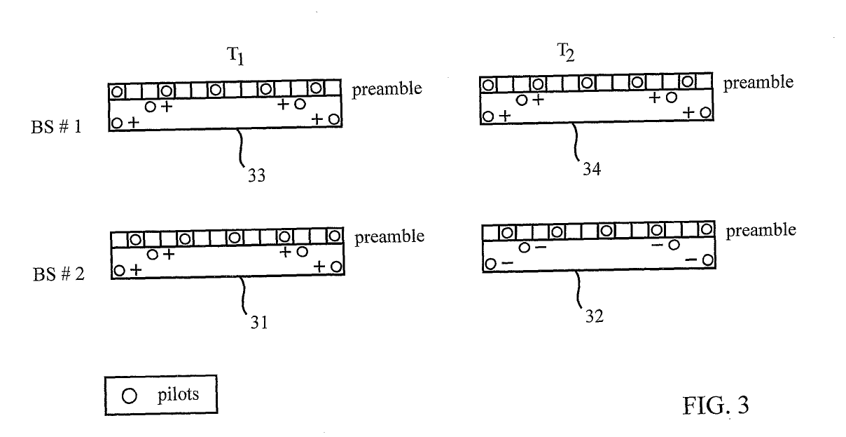

FIG. 3 details signals received from two Base Stations BS#1 and BS#2, at T1 and T2 with Initial Information, such as preamble information in the frame.

The circles represent pilots in different subchannels. For example in 802.16, there are 14 subchannels in the preamble for pilots. It can be seen that the pilots are placed with two spaces, this prevents from pilots of different BSs to be placed on the same subchannels, allowing efficient reception of these pilots and detection of h of each channel in each sample T1 or T2. This can be implemented to more than two BSs and in more points, such as T3, T4 etc.

T1 and T2 can represent two time frames or other kind of intervals, in frequency domain as well. In one embodiment, two signals or frames are received by SS1, a frame 33 from BS1 and a frame 31 from BS#2. It can be implemented that the BSs are synchronized thus the preamble pilots can be received at the same region, and will not interfere each other.

Thus, h3 can be defined for frame 33 and h1 can be defined for frame 31. The received signal Y(1) is their sum. Similarly in T2 two frames are received by SS1, a frame 34 from BS1 and a frame 32 from BS#2. It can be implemented that the BSs are synchronized thus the preamble pilots can be received at the same region, and will not interfere each other. Similarly, h4 can be defined for frame 34 and h2 can be defined for frame 32.

The data of all the frames can further include additional pilots, which can be used to better receive data. These pilots however may be at the same frequencies and/or subchannels of other pilots of other BSs. The sign + or − indicates whether the data from the BS is the same or does its sign is inversed thus the negative value of the data was transmitted.

In yet another embodiment, this indication can be known from the pilots, and whether they are positive or negative.

A method for receiving signals from one BS to a SS, in the presence of two or more BSs includes:
1. Set relevant BSs to transmit the same data k+1 times, possibly as a negative signal some of the times, wherein k is the number of BSs which should be cancelled. Data is transmitted in the same frame and/or time and frequency area by two or more BSs.
2. Each BS transmits Pilots or other indicative signals at the beginning of a frame or other time interval, allowing to find or gather information about the behavior of the communication channel between each BS and the SS.
3. There may be synchronization of signals and frames between BSs so that the signals would be orthogonal with possibly higher PG, and the pilots of each BS will not interfere the others' pilots at an initial time of the frame or interval.
4. The other BSs in conjunction with the data of BS intended to the SS, are programmed, defined or otherwise set to transmit their data in a manner which would allow to cancel the other BSs' data when the signals received by the SS is normalized and combined with the signals of BS1.
5. Receive the data by a SS, which knows or being told how to cancel neighbor or other BSs.
6. Perform mathematical operations identical or equivalent to canceling or reducing the signals of other BSs. Using the k+1 equations it may be possible to cancel other k BSs, remaining with the desired data of BS1.
7. Other BSs can perform this as well, thus it is possible for each BS to better use its resources and still not interfere too much other BSs using the same resources.
8. It is possible to find new transfer functions of the channel, h~. With these transfer functions it is possible to cancel or reduce the signals of other BSs, while Summing up coherently the signals of BS1 in different time intervals and/or frames.

### Remarks:

1. The number of repetitions k may be a parameter set as desired. There may be more repetitions than (the number of BSs+1) for further improving SNR.
2. When using the 802.16, unique pilots of each BS may be placed at the preamble section of the frames, thus allowing the SS to recognize each BS.
3. The repetitions may be done only in subchannels and/or frames and or time and frequency areas where it is decided to implement this method.
4. For 802.16 FUSC can be used instead of PUSC. In addition, in case it is decided to cancel only one BS, one repetition can be enough, instead of making 4 or 6 as might be used according to 802.16.
5. The new invention can be implemented completely in software without requiring any physical changes in hardware. For systems compatible with 802.16, this may be used at the MAC layer, and/or other layers as well.
6. There may be pilots or other signals with the data area as well, in addition to pilots at the beginning of a frame or time interval. These pilots can further help recovering data and identifying channel behavior.
7. In one embodiment, by using four pilots of each BS, it is possible to evaluate the remaining pilots with the aim of identifying them and correcting the data.

In another embodiment, the BSs are synchronized with each other for transmitting the data at the same time and allowing the SS to properly receive data and pilots in expected time regions, such as receiving the pilots at the preamble section of the frame in 802.16. In this embodiment, the BSs transmit the same data, or transmit the negative value of the data. This allows normalizing the equations according to the second, third forth etc BSs and canceling or reducing their effect. For example:

Y(1)=Y_{1,1}+Y_{2,1}+Y_{3,1}+ . . . +Y_{(k+1),1}

. . .

Y(k+1)=Y_{1,(k+1)}+Y_{2,(k+1)}+Y_{3,(k+1)}+ . . . +Y_{(k+1),(k+1)}

The SS only receives k+1 signals: Y(1) . . . Y(k+1), Wherein each Y_{i,j} represents a signal over time period and/or frame at the specified frequency and/or subchannels range from one BS.

Thus, this set of equations represents signals in time and thus the sign of each signal in each time (whether it is positive or negative) should be carefully examined. For example if there are two signals, then one should be ++ (same sign) and the other +−

(opposite sign in the second interval and/or frame), this would allow normalizing and by adding or subtracting the two equations it is possible to cancel the other signal.

Normalizing means may be applied, so that the signal of different Frames or Intervals, would have the same weight when any summation is applied. This can be done as shown before by multiplying each Y(m) with the complex conjugate of its h(m), which is h(m)′ and dividing with the square of its absolute value, which is |h(m)².

By doing so, it is possible to have a sum of the data signals, such as of: D₂₁, . . . , D₂ₘ. By setting the sign of the data, it is possible to cancel the effect of other BSs. Thus, by normalizing and setting the data, it is possible to control how it is summed or canceled.

The resulting signal has a much improved SNR, since signals of other BSs can be treated as known signals which can be effectively cancelled (except for their random noise), allowing to detect the signal of interest at a much better SNR.

Some parts of the current invention relate to the 802.16 standard, or to systems or devices which are adjusted to the Air Interface. These may include a medium access control (MAC) and/or a physical layer (PHY) of fixed point-to-multipoint broadband wireless access systems (FBWA) providing multiple services.

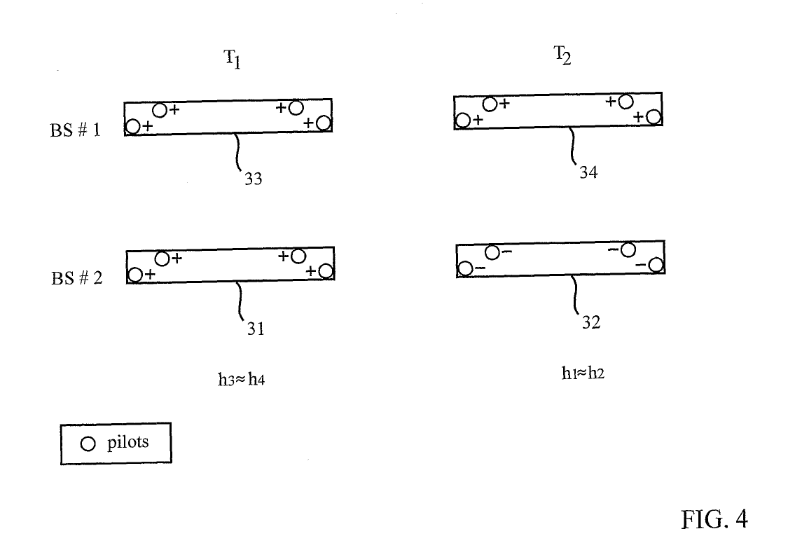

FIG. 4 details signals received from two Base Stations at T1 and T2 without Initial Information. At two points T1 and T2, data is received from BS1 BS2. There may or may not be pilots within the data, however there is no preamble or exact and updated information describing the channel's behavior.

Assuming that the channels of BS1 did not change too much between T1 and T2, and that it was set that Data 33, D11 through h3 from BS1 at T1 and Data 34 D12 through h4 from BS1 at T2, delivered the same data, and that:

the channels of BS2 did not change too much between T1 and T2, and that it was set that Data 31, D21 through h1 from BS2 at T1 and Data 32 D22 through h2 from BS2 at T2, delivered the negative of the same data, using the following approach it is possible to cancel the signals of BS#2, and find those of BS#1:
Signal received at T1: Y(1)=D₁₁*h₃+D₂₁*h₁
Signal received at T2: Y(2)=D₁₂*h₄+D₂₂*h₂

No change over time, thus: h₁=h₂ and h₃=h₄ (this is an assumption, and this is not precise in practice, but even so it is helpful)

Y(1)=D₁₁*h₃+D₂₁*h₁ Y(2)=D₁₂*h₃+D₂₂*h₁

Knowing that:

D₁₁=D₁₂ (BS#1 keeps the same signal)
D₂₁=−D₂₂ (BS#2 transmits the opposite signal) then:

Y=Y(i)+Y(2)=2*D₁₁*h₃

Y=Y(1)−Y(2)=−2*D₂₂*h₁

Thus the data of BS#1 and BS#2, D₁₁ and D₂₂ respectively, can be found.

The MAC is capable of supporting multiple PHY specifications optimized for the frequency bands of the application.

The standard includes a particular PHY layer to systems between 10-66 GHz.

The present invention may be used with 802.16 2004 with revisions for MAC and PHYs for 2-11 GHz. The present invention may be used with 802.16a.

The present invention may be used with 802.16e, such as for combined fixed and mobile in Licensed Bands. For WMAN Wireless Metropolitan Broadband Access technologies, the implementations may include:

SME and residential customers needs; Data, Voice, Video distribution and Real-time videoconferencing.
Network operators demands: Ubiquitous coverage (rural area, wireless backhaul to hot-spots), “On-demands” bandwidth and Cost effective solutions.

The model of WMAN for 802.16 may include one or more Base Stations BS, which are connected to the public networks and provide Subscriber SS access For possibly multiple services, such as: voice, video, data and terminals (PDA, back-haul to WLAN AP etc.) It may be used in relatively large scale of range and number of users.

The WMAN for 802.16 may support Flexible channels, both License and Unlicensed, TDD\FDD\HFDD, Outdoor, Line Of Sight LOS and NLOS

No Line Of Sight systems, Advanced Antenna, adaptive coding and modulation and mesh topology. WMAN for 802.16 may be implemented for hundreds of users per channel.

This invention can be used in other wireless networks for receiving only the relevant data for a SS, while canceling other BSs. The SS can ask for repetitions from BS1, and then BS1 can notify other relevant BSs to use repetitions, in which frequencies or subchannels, and in what manner.

In another embodiment, there is a problem of capacity, thus it is required not to use PUSC, without having to use sectors between BSs, and without having many errors.

It may be possible to use FUSC with a minimal number of repetitions. HO operations can be done better and the data of other BSs can be treated as known data, which can be cancelled.

Pilots which are in the data and do not carry data, can further help to retrieve the channel and find the data, assuming the channel's behavior was found with h~.

It is possible to average pilots in order to improve SNR, such as in the presence of a white noise N₀. In case the signals are coherent with each other, then a 6 dB improvement in SNR can be achieved when adding two data signals. Otherwise, only 3 dB improvement can be reached.

Throughout the present invention, it may be useful to use two or more antennas at a MS. This may help in deciding the direction of the signal of interest and cancel or attenuate other signals, receive more data and/or use a larger bandwidth, using wider protocols and/or using other types of OFDMA signals.

Some systems and/or methods presented in the present application can be used with OFDM and/or OFDMA systems, such as with FFT sizes of 512 to 4096. Such methods and/or systems may use, or be referred as, scalable OFDMA systems and/or methods.

802.16 systems, with optional MAC, may support voice, video and data. The MAC may support differentiated service levels as T1 for business and improved services for residential customers.

Some embodiments may relate and/or be used with standards and/or systems supporting properties similar to the 802.16 IEEE Standard. These properties may include any of the following or a combination thereof:
Broad bandwidth (20, 25 and 28 MHz).
Up to 134 Mbit/s @ 28 MHz channel, 64QAM.
Supporting multiple services simultaneously with full QoS.
Efficiently transport IPv4, IPv6, ATM, Ethernet, etc.
Bandwidth on demand (frame by frame).
MAC designed for efficient usage of spectrum.
Comprehensive, modern, and extensible security.
Support for multiple frequency allocations from below 11 GHz and up to 66 GHz.
OFDM and OFDMA for NLOS applications.
Up to 50 Km cell radius.
Using Duplex Compatible systems including: TDD and/or FDD and/or H-FDD.
Link adaptation including Adaptive modulation and coding, such as: Subscriber by Subscriber, Burst by Burst, Uplink and Downlink.
Point-to-multipoint topology, with or without mesh extensions.
Support for adaptive antennas.
Space-time coding and MIMO schemes.
Optimized for Fixed and Mobile deployment scenarios.

Systems which support Time-Division Duplex TDD, may include any of the following properties or a combination thereof:
DL and UL time-share the same RF channel.
Dynamic asymmetry.
Half Duplex—SS does not transmit/receive simultaneously—may help reduce cost.

Systems which support Frequency-Division Duplex FDD may include any of the following properties or a combination thereof:
Downlink and Uplink on separate RF channels.
Static asymmetry.
Support for Half-duplex FDD.

Properties relating to Mobility may include any of the following properties or a combination thereof:
Contiguous Coverage Cellular infrastructure, Handover, Roaming and Turbo Encoding.
Dynamic channel estimation: moving pilots and mid-amble.
Low Power: Paging, Sleep/Paging.

Properties relating to CAPEX/OPEX may include any of the following properties or a combination thereof:
Increased Cell Radius: Long Delay Spread such as 10-20 uSec, AAS, sub channels.
Spectral Efficiency: Frequency Reuse, up to 64-QAM, orthogonal modulation.

Properties enabling adaptive PHY Modulation may allow a Tradeoff Between Link Robustness and Capacity. Responsive to link conditions in real time, a higher order modulation can be used when the signal to noise ratio SNR is in a required level, or the link performance may be improved by using some embodiments described in this application. The Modulation can be QPSK, 16 or 64 QAM.

The modulation may be adapted to the situation, such as on a subscriber-by-subscriber or a burst-by-burst basis.

Properties which relate to Wireless MAN-SCa may include any of the following properties or a combination thereof:
Single Carrier.
Using 10-66 GHz, Licensed Bands at Line of Sight LOS.
May be used outdoors and between BSs.

Properties which relate to Wireless MAN-SCa may include any of the following properties or a combination thereof:
Single Carrier and/or sub-channels usage.
Using 2-11 GHz Licensed Bands, Non Line of Sight NLOS.

Properties which relate to Wireless MAN-OFDM may include any of the following properties or a combination thereof:
Using Orthogonal Freq. Division Multiplexing, such as with 256 sub-carriers.
Using 2-11 GHz Licensed Bands, Non Line of Sight NLOS.
Fixed Indoor Applications.

Properties which relate to Wireless MAN-OFDMA may include any of the following properties or a combination thereof:
Using Orthogonal Freq. Division Multiple Access, such as with 2048 sub-carriers.
Using 2-11 GHz NLOS, Licensed Bands.
Mobile Applications.

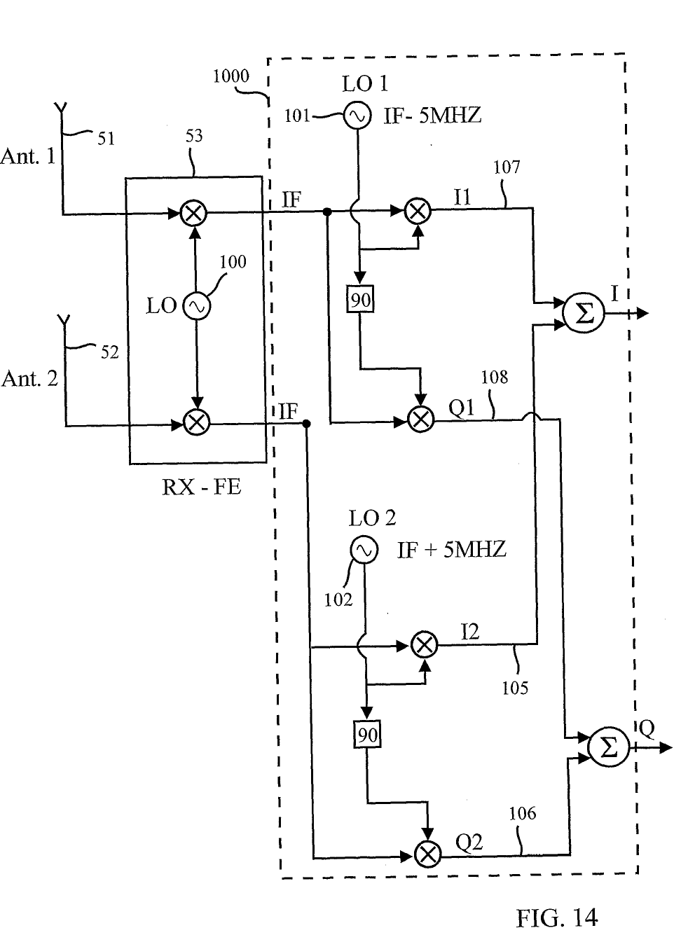

FIG. 14. details a system for receiving signals of two antennas 51 and 52 using a wider spectrum.

In one embodiment, the two antennas 51 and 52, also marked as Ant. 1 and Ant. 2, allow receiving two signals at the same center frequency and/or channels and/or frames. The two antennas 51 and 52 may serve as an adaptive array of antennas with one Receiver Front End. The Receiver Front End Rx-FE 53 may include one or more Local Oscillators, such as LO 100, which are capable of down converting the signals. It is possible to use one standard unit 53, used at the RX-FE, with antennas included or externally connected.

Adaptive Antenna System AAS refers to a system, which uses more than one antenna to improve the coverage and the system capacity. Using two antennas may be equivalent to transmitting 3 signals, thus improving capacity. Using any of the implementations presented in this paper, it can be possible to use and/or present AAS, with or without additional means.

Synchronization can be used so that two or more signals could be placed on the same spectrum and treated as one signal. It may be possible to use two or more synchronization mechanisms, for example in order to synchronize on two signals from two antennas. It may also be possible to use one combined synchronization mechanism, for example if two or more signals are close enough in time to each other and/or if it is possible to use one sampling mechanism and/or if the signals include repetitions.

Diversity can be used in order to combine two or more received signals in order to improve the received signal quality. This may include identifying signals coming from different BSs using more than one antenna and/or using repetitions in time and/or different frequencies and/or different sub-channels and/or different channels and/or different frames, etc. It is preferred that the signals would have minimum or zero correlation between them. However, for some embodiments, there may be correlation between received signals—such as by using two or more antennas for receiving from a direction of one BS.

Space Diversity—may be used, such as by using several antennas. The placement and type of the antennas may be considered, such as for receiving signals with a minimum correlation.

Polarization Diversity—May be implemented using two or more antennas.

Frequency Diversity—One or more signals from one or more BSs may be transmitted at different frequencies.

Time Diversity—Signals may be transmitted on different points in time, for example in different frames.

Scalable OFDMA—Using existing resources of an OFDMA and/or OFDM system, it may be possible to combine two or more signals into one signal. For example in standard 802.16e, it may be possible to combine two, four, etc. narrower band signals into one combined signal, using the same hardware resources. This may be useful for example for signals in the sizes of 512, 1024, 2048 and 4096 which may be not part of the standard, but such hardware resources can still be used to combine two 2048 signals, for example. In addition, more than one system can be combined, allowing to concurrently receive two or more signals.

These techniques can be combined with one or more antennas, thus it may be possible to use more than one antenna and/or more than one Front End and/or receiver means, in order to receive several signals using one system and/or existing hardware.

PN Offset—Pseudo Noise Code Offset, may refer to a delay applied to a random number sequence at a BS. Each BS has a different PN allowing SS to receive signals of different BSs with different delays. This can help rejecting signals of other BSs.

In the present invention, PN signals may be based on absolute criteria and preferably should not be random. Thus, it may be possible to better combine such signals and synchronize between BSs, which may help to achieve better results.

Image rejecting filters may be used as known in the art, to prevent or attenuate possible image signals. Additional filters, amplifiers and LNA components may be used to reduce noise and adjust the signal as required. These filters and additional components may be used at the RX-FE and/or at different locations of the system, such as at IF.

In one embodiment, the Local Oscillator 100 shifts the frequencies of the signals from the two antennas to IF. Preferably, the bandwidth of the signal of interest received through Ant. 1 is 2×ΔF_{LO} or less.

A Local Oscillator 101 LO1, tuned to a center frequency of IF−ΔF_{LO} is shifted by 90 degrees and multiplied with the IF signal of Ant. 1 for setting I and Q of Ant. 1 about a center frequency of ΔF_{LO}. For example, in this embodiment, ΔF_{LO}=5 MHz and the center frequency of LO1 is IF−5 MHz.

The signals referred as I1 and Q1, represent the I and Q components respectively of the signal of Ant. 1.

It is possible to take only the components of Zero IF, thus the signals I1 107 and Q1 108, may be about a center frequency of ΔF_{LO}. This may be implemented, for example, using a LPF with a cutoff frequency of 2×ΔF_{LO} placed after each of the two multipliers with the signal of LO1.

Thus, the signal I1 107, which is the I component of the signal of Ant. 1, may be placed in the frequency range of 0÷2×ΔF_{LO}, which in this example is 0÷10 MHz. The signal of Q1 108, which is The Q component of the signal of Ant. 1, may be similarly placed in the same range of 0÷2×ΔF_{LO}, which in this example is 0÷10 MHz.

A second Local Oscillator 102 LO2, tuned to a center frequency of IF+ΔF_{LO} is shifted by 90 degrees and multiplied with the IF signal of Ant. 2 for setting I and Q of Ant. 2 about a center frequency of −ΔF_{LO}. For example, in this embodiment

ΔF_{LO}=5 MHz and the center frequency of LO2 is IF+5 MHz.

The signals referred as I2 and Q2, represent the I and Q components respectively of the signal of Ant. 2.

It is possible to take only the components of Zero IF, thus the signals I2 105 and Q2 106, may be about a center frequency of −ΔF_{LO}. This may be implemented, for example, using a LPF with a cutoff frequency of 2×ΔF_{LO} placed after each of the two multipliers with the signal of LO2.

Thus, the signal I2 105, which is the I component of the signal of Ant. 2, may be placed in a frequency range of −2×ΔF_{LO}÷0, which in this example is

### −10÷0 MHz.

The signal of Q2 106, which is The Q component of the signal of Ant. 2, may be similarly placed at the same range of −2×ΔF_{LO}÷0, which in this example is −10÷0 MHz.

Since I1 and I2 are on different areas of the spectrum, they may be added to create one new signal I.

Since Q1 and Q2 are on different areas of the spectrum, they may be added to create one new signal Q.

A unit 1000, which may be used for placing signals of the same frequencies, originating from two antennas, can be implemented for finding the I and Q components of these signals and placing them together on one spectrum.

The unit 1000 may include two IF signal inputs, and may deliver to outputs of I and Q with Zero IF. The Rx-FE and/or the antennas, may be combined with the unit 1000, to form a receiver unit for two antennas.

The new signals I and Q at the output of the unit 1000, can be very useful. Systems which have two inputs, or in which it is desired to use only two inputs for the signals from the two antennas, can be connected to Ant. 1 and Ant. 2, for example, using the new I and Q as its inputs.

In a preferred embodiment, in OFDMA and/or OFDM and/or 802.16—compatible systems, it will be possible to use the system for receiving new I and Q values, by treating the new signal comprising the new I and Q components, as one signal with a bandwidth twice as wide.

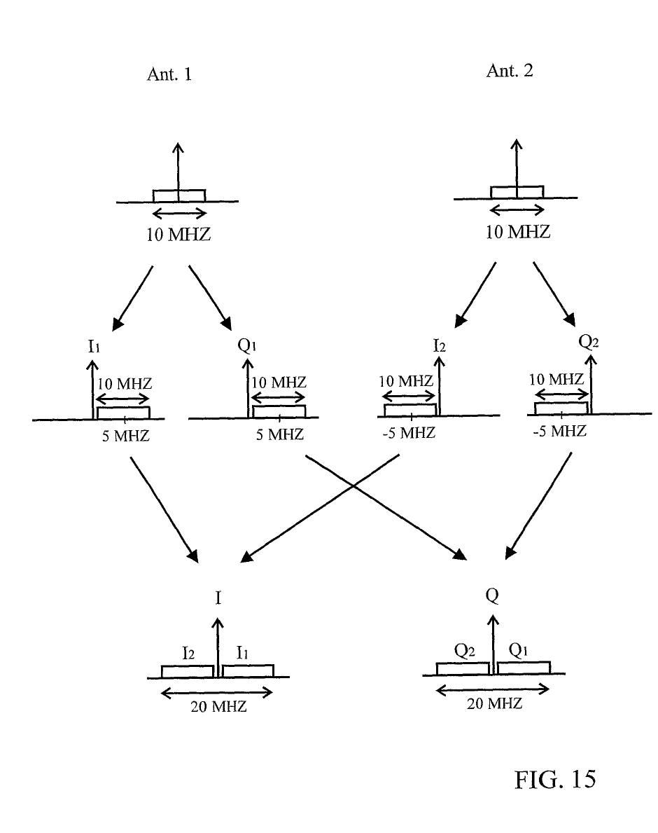

FIG. 15 Illustrates a frequency spectrum of the signals of the system of FIG. 14 with the Spectrum of the Signals from Ant. 1 and Ant. 2, placed on one spectrum.

I and Q are created using an equivalent method. The output signal has a double bandwidth of either signals at the input.

In a preferred embodiment, it may be possible to use a system compatible with a larger FFT Size and/or N_{FFT} parameter, for receiving the two new I and Q signals.

Thus, from two signals each represented by a bandwidth of ΔF_{LO}, the I and Q components are found, shifted and combined into one spectrum.

The two new spectrums formed, I and Q, have a bandwidth of 2×ΔF_{LO} each. This may be equivalent, in one embodiment, to receiving two signals of FFT size and/or N_{FFT} of 512, and after combining them, reading the I and Q similarly to reading a signal with FFT Size and/or N_{FFT} in the size of 1024.

The Standard 802.16 and others may support signals with FFT Size and/or N_{FFT} of 2048, which may be capable of reading two signals of 1024, four signals of 512, etc. However it is possible to present a system which supports FFT Size and/or N_{FFT} of 4096, and even though it might not support a standard which is defined to be compatible with FFT Size and/or N_{FFT} of up to 2048, such a system can still be used such as by using embodiments described in this invention.

Thus, a system compatible to FFT Size and/or N_{FFT} of 4096, can receive two signals of 2048, four signals of 1024, etc.

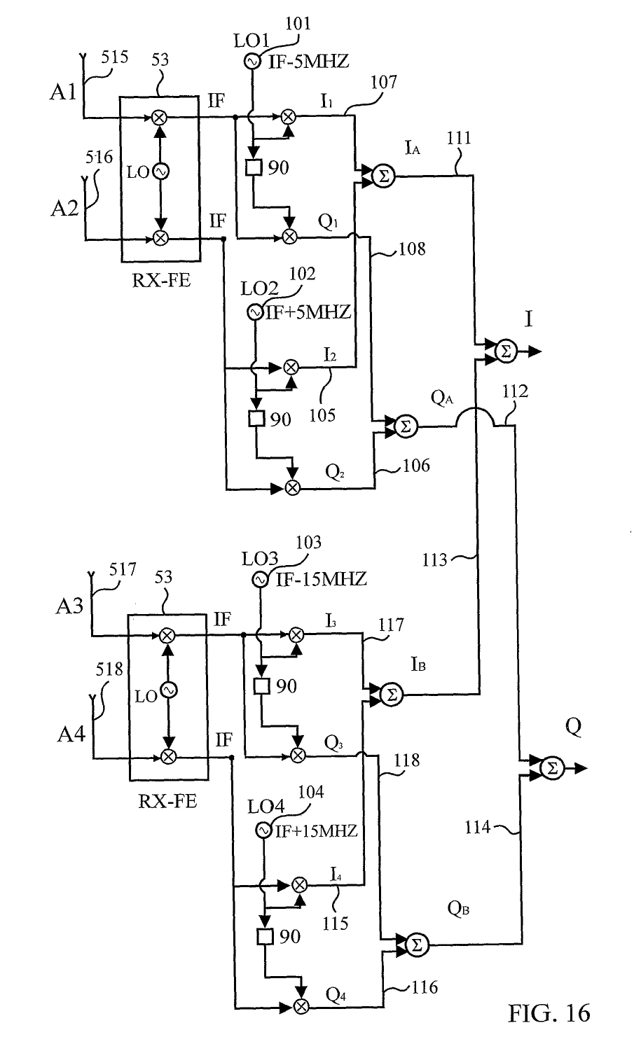

FIG. 16 Details a system for receiving signals from four antennas A1-A4, using a wider spectrum with the same IF frequency.

In one embodiment, it is possible to use two Rx-FE 53 units, similar to the one described in FIG. 14. Using one unit may reduce costs and/or simplify its implementation.

The four Antennas A1-A4, 515-518 respectively, can be used to further increase the effect of two antennas. Considerations similar to using two antennas rather than one can be applied for using four antennas rather than two antennas or one.

The array of four antennas 515-518, may comprise a double pair of antennas, such as 515-516 and 517-518, where each such a pair may be further used with its own RF Front End 53. In case no standard Rx-FE unit is used, one LO can be used for all antennas. The Local Oscillator reduces the frequency of the signals to IF.

In a preferred embodiment, an LO1 101 is used as a Local Oscillator for setting I and Q of Ant. 1 about a center frequency of 5 MHz for example, or about other frequency ΔF_{LO} which may be the difference frequency between LO1 and the IF frequency. The signals formed similarly to the ones created in FIG. 14, are referred as I1 and Q1 respectively, where I1 107 is the I component of the signal of A1 and Q1 108 is the Q component of the signal of A1.

In this embodiment, LO2 102 is used as a Local Oscillator for setting I and Q of A2 about a center frequency of −5 MHz for example, or about other frequency −ΔF_{LO} which may be the difference frequency between LO2 and the IF frequency.

The signals formed similarly to the ones created in FIG. 14, are referred as I2 and Q2 respectively, where I2 105 is the I component of the signal of A2 and Q2 106 is the Q component of the signal of A2.

LO3 103 is a Local Oscillator used for setting I and Q of A3 about a center frequency of 15 MHz for example, or 3×ΔF_{LO}. The signals created by LO3 are referred as I3 and Q3 respectively, wherein I3 117 is the I component of the signal of A3 and Q3 118 is The Q component of the signal of A3.

LO4 104 is a Local Oscillator used for setting I and Q of A4 about a center frequency of −15 MHz for example, or −3×ΔFLO. The signals created by LO4 are referred as I4 and Q4 respectively, wherein I4 115 is the I component of the signal of A4 and Q4 116 is The Q component of the signal of A4.

The sum IA 111 of I1 and I2, is set as the spectrum of I at −10 MHz<f<10 MHz for example, or at −2×ΔF_{LO}<f<2×ΔF_{LO} in the more generalized embodiment.

The sum IB 113 of I3 and I4, is set as the spectrum of I at −20 MHz<f<−10 MHz and 10 MHz<f<20 MHz for example, or at −4×ΔFLO<f<−2×ΔF_{LO} and 2×ΔF_{LO}<f<4×ΔF_{LO} in the more generalized embodiment.

The sum QA 112 of Q1 and Q2, is set as the spectrum of Q at −10 MHz<f<10 MHz for example, or at −2×ΔF_{LO}<f<2×ΔFLO in the more generalized embodiment.

The sum QB 114 of Q3 and Q4, is set as the spectrum of Q at −20 MHz<f<−10 MHz and 10 MHz<f<20 MHz for example, or at −4×ΔFLO<f<−2×ΔFLO and 2×ΔFLO<f<4×ΔFLO in the more generalized embodiment.

The I component is the sum of IA and IB.

The Q component is the sum of QA and QB.

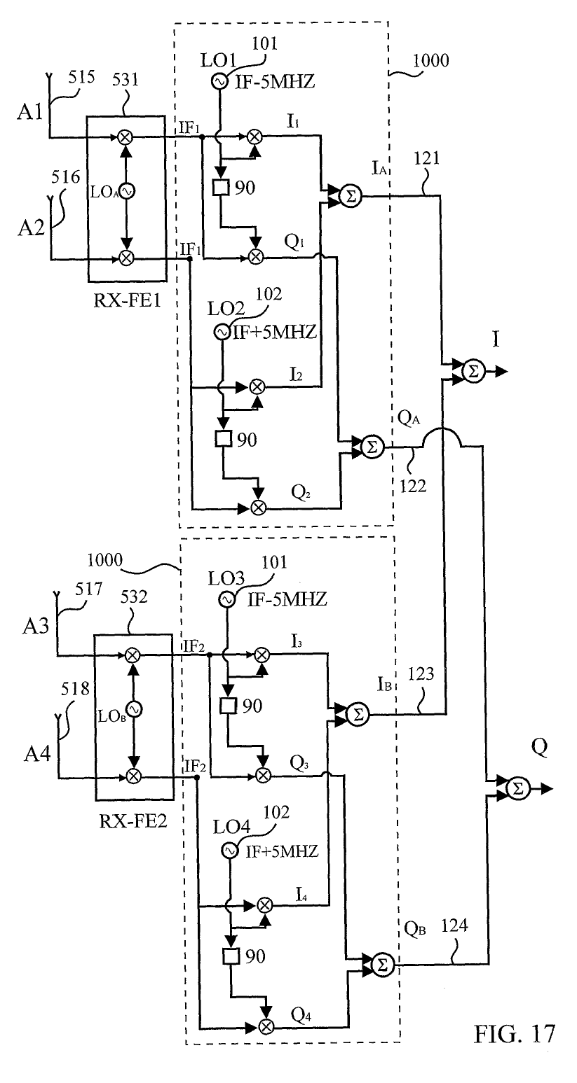

FIG. 17 details a system for receiving signals from four antennas A1-A4, using a wider spectrum with the same IF module 1000.

In this embodiment, two Rx-FE units are used, wherein each of them has a different LO frequency.

A possible array of four antennas, may comprise a double pair of antennas:

### A1-A2 515-516 and A3-A4 517-518.

The same IF module 1000 can be used for each pair of antennas, however it should be tuned to work with a different IF frequency. Yet in another embodiment, possible Image rejecting filters and/or other filters or hardware components which require tuning are not used and/or are not within the IF module, thus the same IF module 1000 can be used for different IF frequencies.

In this embodiment, the first pair of antennas is connected to LO_{A} which down converts the RF signals of these antennas. It is possible to use a standard and/or tuned unit 531, referred as Rx-FE1, with antennas included or externally connected.

The second pair of antennas is connected to LO_{B} which down converts the RF signals of its antennas. It is possible to use a standard and/or tuned unit 532, referred as Rx-FE2, with antennas included or externally connected.

Image rejecting filters may be used as known in the art, to prevent or attenuate possible image signals. Additional filters, amplifiers and LNA components may be used to reduce noise and adjust the signal as required. These filters and additional components may be used at the Rx-FE and/or at different locations of the system, such as at each IF level, thus it may be tuned for IF1 and IF2.

In this embodiment, the Local Oscillators LO_{A} and LO_{B} shift the frequencies of the signals from the two pairs of antennas to IF1 and IF2, respectively.

Since the two IF frequencies are different, the outputs of units 1000 are at different frequency allocations.

Preferably, the bandwidth of each of the signals of interest received through the antennas is 2×ΔF_{LO} or less.

LO1 101 and LO3 101 are set to work on a frequency of IF−ΔF_{LO} in the general case or at IF−5 MHz for example.

The center frequency of the signals I1 and Q1 can thus be: IF1−IF+ΔF_{LO}

The center frequency of the signals I3 and Q3 can thus be: IF2−IF+ΔF_{LO}

LO2 102 and LO4 102 are set to work on a frequency of IF+ΔF_{LO} in the general case or at IF+5 MHz for example.

The center frequency of the signals I2 and Q2 can thus be: IF1−IF−ΔF_{LO}

The center frequency of the signals I4 and Q4 can thus be: IF2−IF−ΔF_{LO}

Additional filters can be placed before adding IA and IB to form I and before adding Q_{A} and Q_{B} to from Q. This can be useful to reject image frequencies made by the LOs of units 1000.

By setting IF1 and IF2, it is possible to place the spectrums of the signals of the first and second pairs of antennas.

In a preferred embodiment, |IF1−IF2=4×ΔF_{LO}. This allows placing the spectrums of the signals near each other in the frequency domain while preventing them from interfering with each other.

In another preferred embodiment, it is possible to set either:

### IF1=IF+2×ΔF_{LO} and IF2=IF−2×ΔF_{LO} OR

### IF2=IF+2×ΔF_{LO} and IF1=IF−2×ΔF_{LO}.

This would allow further placement of the spectrums of the signal about a center frequency of Zero IF.

It may be possible, in embodiment where |IF1−IF2|=4×ΔF_{LO}, to place additional means, such as one or more filters and/or one or more LOs, in order to down convert the overall signal to Zero IF.

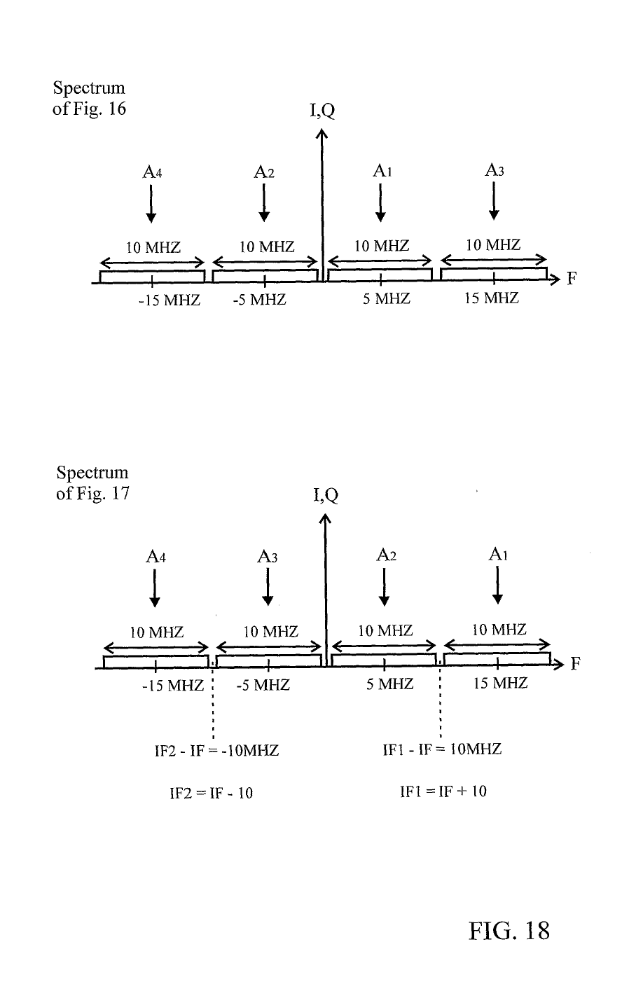

FIG. 18 Illustrates frequency spectra of the systems of FIGS. 16 and 17. These spectra are examples of additional possibilities and systems, which may be implemented for arbitrary frequency values.

In the first example, using the system of FIG. 16, the spectrum of the I and Q signals at the output, originating by placing the signals of A1 to A4 on one spectrum, is shown. As described in the example in FIG. 16, the center frequency of each signal will be summarized:

TABLE 1

| | Center Frequency - | | Center Frequency - |
|---|---|---|---|
| Signal/Antenna | Example | | General Case |
| A1 | 5 | MHz | ΔF_{LO} |
| A2 | −5 | MHz | −ΔF_{LO} |
| A3 | 15 | MHz | 3 × ΔF_{LO} |
| A4 | −15 | MHz | −3 × ΔF_{LO} |

In the more general case, the bandwidth of each of the signals at A1 to A4 should preferably be and/or set to: BW≦2×ΔF_{LO}. In the example, the bandwidth of each signal is limited to 10 MHz, and the overall bandwidth of either I or Q is 40 MHz.

In the general case, I and Q are created using an equivalent method. The output signal has four times the bandwidth of each of the signals at the input.

It can be seen that the signals of A1 and A2 can be placed in the same manner as for a system with only two antennas. In other embodiments, it may be possible to use a different hardware in order to create this spectrum.

In the second example, using the system of FIG. 17, the spectrum of the I and Q signals at the output, originating by placing the signals of A1 to A4 on one spectrum, is shown. As described in the example in FIG. 17, the center frequency of each signal will be summarized:

TABLE 2

| | Center Frequency - | | Center Frequency - |
|---|---|---|---|
| Signal/Antenna | Example | | General Case |
| A1 | 15 | MHz | (IF1 − IF) + ΔF_{LO} |
| A2 | 5 | MHz | (IF1 − IF) − ΔF_{LO} |
| A3 | −5 | MHz | (IF2 − IF) + ΔF_{LO} |
| A4 | −15 | MHz | (IF2 − IF) − ΔF_{LO} |

In the more general case, the bandwidth of each of the signals at A1 to A4 should preferably be and/or set to: BW≦2×ΔF_{LO}. In the example, the bandwidth of each signal is limited to 2×ΔF_{LO}=10 MHz, IF1=IF+2×ΔF_{LO} and IF2=IF −2×ΔF_{LO} and the overall bandwidth of either I or Q is 4×ΔF_{LO}=40 MHz.

In the general case, I and Q are created in an equivalent method. The output signal has a bandwidth four times that of each of the signals at the input.

It can be seen that the signals of A1 and A2 can be placed near each other. In other embodiments, it may be possible to use a different hardware in order to create this spectrum. The exact shaping of the spectrum and the placement of each signal can be important. For example, when applying FFT and/or IFFT the signals may be different and may have different properties if the signals of the antennas are placed in other manners. The new signal can be treated as one signal with a larger bandwidth, such as in 802.16 systems.

Some OFDMA symbol parameters may have the following values, preferably while using some of the presented embodiments or a combination thereof:

TABLE 3

| Parameters | Value |
|---|---|
| FFT Size - NFFT | 2048 |
| Number of Data Carriers | 1536 |
| F_{S} - Sampling Frequency | 8/7*BW |
| Δf - Sub Carrier Frequency Spacing | Fs/N_{FFT} |
| T_{b} - Useful Symbol Time | 1/Δf |
| T_{g} (Guard Time)/T_{b} | ¼, ⅛, 1/16, 1/32 |
| OFDMA Symbol Rate | 1/Ts = 1/(Tb + Tg) |

Bit Rate = [OFDMA Symbol Rate] * [Modulated Bits] * [Data sub carriers]

Some OFDMA Data Rates may have the following values in Mbps, preferably while using some of the presented embodiments or a combination thereof:

TABLE 4

| | | | | 16 | 16 | 64 | 64 | 64 |
|---|---|---|---|---|---|---|---|---|
| | | QPSK | QPSK | QAM | QAM | QAM | QAM | QAM |
| | | ½ | ¾ | ½ | ¾ | ½ | ⅔ | ¾ |
| 1.25 | MHz | 1.04 | 1.61 | 2.14 | 3.21 | 3.21 | 4.29 | 4.82 |
| 3.5 | MHz | 2.91 | 4.50 | 6.00 | 9.00 | 9.00 | 12.00 | 13.50 |
| 7.0 | MHz | 5.82 | 9.00 | 12.00 | 18.00 | 18.00 | 24.00 | 27.00 |
| 14.0 | MHz | 11.64 | 18.00 | 24.00 | 36.00 | 36.00 | 48.00 | 54.00 |
| 28.0 | MHz | 23.27 | 36.00 | 48.00 | 72.00 | 72.00 | 96.00 | 108.00 |
| 10.0 | MHz | 8.31 | 12.86 | 17.14 | 25.71 | 25.71 | 34.29 | 38.57 |
| 20.0 | MHz | 16.62 | 25.71 | 34.29 | 51.43 | 51.43 | 68.57 | 77.14 |

In this table, MAC and preamble overhead may not be included in the calculation. In addition, the Bit Rate may be shared between DL and/or UL and/or SS.

Possible System Profiles using OFDMA:

TABLE 5

| | | | | | Max | |
|---|---|---|---|---|---|---|
| | | Frame | | Available | Bit Rate | |
| | BW | Size | RF bands | RF | OFDMA- | |
| Profile | (MHz) | (mSec) | (GHz) | Channels | 2K | |
| P1-Licensed | 1.25 | 5, 12.5 | 2.5, 3.5 | 420 | 5 | mbps |
| P2-Licensed | 3.5 | 5, 12.5 | 2.5, 3.5 | 225 | 14 | mbps |
| P3-Licensed | 7 | 2.5, 4, 8 | 2.5, 3.5 | 215 | 27 | mbps |
| P4-Licensed | 14 | 2.5, 4, 8 | 2.5, 3.5 | 196 | 54 | mbps |
| P5-Licensed | 28 | 2.5, 4, 8 | 2.5, 3.5 | 150 | 108 | mbps |
| P6-Unlicensed | 10 | 2.5, 5, 8 | 5 | 30 | 39 | mbps |
| P7-Unicensed | 20 | 2.5, 5, 8 | 5 | 20 | 75 | mbps |

Available RF Channels may refer to an aggregation of all international spectrum Cell Sectors and Cell Capacity.

Some embodiments may be adjusted for supporting cell sectors and/or different capacity options: OFDMA enables Cell Planning with frequency reuse.

Frequency Reuse in OFDMA may preferably include using some of the following properties or a combination thereof:
Different sub channel and/or sub carriers permutation per cell.
PUSC—Partial Usage of Sub-channels per sector.
Pilots allocation and Preamble per Sector.
Preamble modulation series per cell.

The present disclosure is but one example of system and method embodiments for implementing the present invention, and that various modification will occur to persons skilled in the art upon reading the present disclosure and the related drawings.

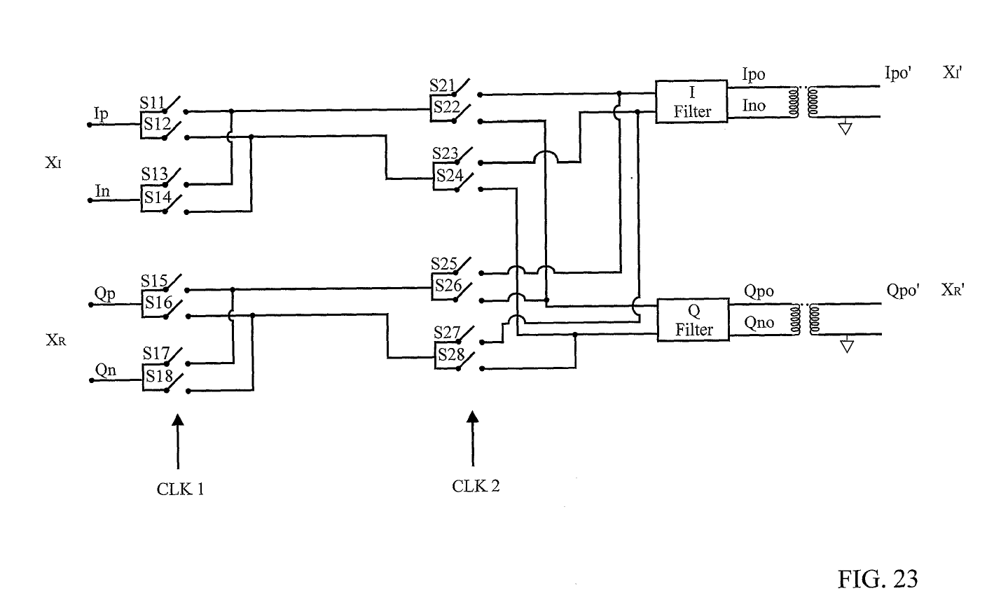

FIG. 23 Details a system for shifting a complex signal using switching means.

It is desired to receive two base-band signals on the same spectrum, that is receiving two signals at the same center frequency and/or channels and/or frames.

An embodiment of a system for implementing this function may include hardware means which include switches or equivalent means.

### Method of Operation:

Using for example the above system, each of two source signals, with a frequency spectrum in the range of −fₙ<f<fₙ, should be sampled in a rate of: fₛ>4fₙ.

This would result in two discrete signals in frequency domain: X₁(e^{jω}) and X₂(e^{jω}) wherein each captures up to half of the discrete spectrum, thus with a spectrum in the range of −π/2<ω<π/2.

It is then required to shift the center frequency of one of the signals, to Δω=π/2 so that it will be possible to sum the signals into one spectrum.

While it is possible to use embodiments in which two or more Analog to Digital converters A/D's are placed, it may also be desirable to only use one A/D for the I signal and one A/D for the Q signal.

In particular, this may allow using existing hardware with two A/D's or other sampling mechanism—one for I and one for Q, rather than four A/D's—two for the I and Q components of each of the two signals.

Similarly, it may be possible to use one A/D, wherein the separation to the I and Q components is done afterwards, or is not required.

Shifting the frequency of a signal X to a different, higher radian frequency distanced Δω radians/second, is defined in the discrete frequency domain as: X(e^{j(ω-Δω)}).

In the discrete time domain, shifting the signal X is equivalent to multiplying the discrete signal, wherein n is the discrete time (n is integer): X_{I}[n]*e^{jΔω}*ⁿ

The signal is comprised of a Real and an Imaginary components:

Continuous signal: x(t)=x_{R}(t)+j*x_{I}(t) Discrete signal. x[n]=x_{R}[n]+j*x_{I}[n]

The exponent is: e^{jΔω}*ⁿ=e^{j(π/2)}*ⁿ=cos(π*n/2)+j*sin(π*n/2)

Thus, the resulted exponent expression e^{jΔω}*ⁿ is comprised of real and imaginary parts, which can only have the values: −1, 1 or 0.

It is possible to derive:

$$\begin{matrix}{X}_{1} [ n ] * {e}^{jΔω * n} = ( {x}_{R} [ n ] + j {x}_{I} [ n ] ) * ( cos ( π * n / 2 ) + j * sin ( π * n / 2 ) ) \\ = \{ {x}_{R} [ n ] * cos ( π * n / 2 ) - {x}_{I} [ n ] * sin ( π * n / 2 ) \} + \\ j * \{ {x}_{R} [ n ] * sin ( π * n / 2 ) + {x}_{I} [ n ] * cos ( π * n / 2 ) \} \\ ≡ {x}_{R}^{′} [ n ] + j * {x}_{I}^{′} [ n ]\end{matrix}$$

Where x_{R}′[n] and x_{I}′[n] are the Real and an Imaginary components of the shifted signal, respectively. These components represent the new signal shifted in the discrete frequency domain.

An angle component Θ, is defined as Θ≡π*n/2. Since Θ can have only four relevant values: 0, 90, 180 and 270 degrees, for the sin(Θ) and cos(Θ) expressions, the following table summarizes all the possibilities.

TABLE 1
Possible Components values

| | Θ ≡ 0 | Θ ≡ π/2 | Θ ≡ π | Θ ≡ 3*π/2 |
|---|---|---|---|---|
| | n = 0, 4, | n = 1, 5, | n = 2, 6, | n = 3, 7, |
| Component | 8 . . . | 9 . . . | 10 . . . | 11 . . . |
| x_{R}′[n] = | x_{R}[n] | −x_{I}[n] | −x_{R}[n] | x_{I}[n] |
| x_{I}′[n] = | x_{I}[n] | −x_{R}[n] | −x_{I}[n] | −x_{R}[n] |

Thus, according to table 1, in order to implement the frequency shift of the signals, the original components of X[n]: the real part x_{R}[n] and the imaginary part x_{I}[n] should be switched, according to one of these four values of Θ.

An embodiment, such as the one described in FIG. 23, allows implementing the abovementioned operation.

Iₚ and Iₙ are the positive and negative terminals of the Imaginary component of the input signal, respectively. For example, this may be the X_{I} signal.

Qₚ and Qₙ are the positive and negative terminals of the Real component of the input signal, respectively. For example, this may be the X_{R} signal.

Iₚₒ and Iₙₒ are the positive and negative terminals of the Imaginary component of the shifted output signal, respectively. For example, this may be the X_{R}′ signal.

Iₚₒ′ may be equal to: Iₚₒ−Iₙₒ thus it is the X_{I}′ signal relative to relevant ground using a transformer.

Qₚₒ and Qₙₒ are the positive and negative terminals of the Real component of the shifted output signal, respectively. For example, this may be the X_{R}′ signal.

Qₚₒ′ may be equal to: Qₚₒ−Qₙₒ thus it is the X_{R}′ signal relative to relevant ground using a transformer.

Using the switches it is possible to output any combination of the input signal, to match the operation of Table 1.

Only one switch at the first level is closed for each pair of switches, these pairs are:

### S₁₁-S₁₂, S₁₃-S₁₄, S₁₅-S₁₆ and S₁₇-S₁₈.

Only one switch at the second level is closed for each pair of switches, these pairs are:

### S₂₁-S₂₂, S₂₃-S₂₄, S₂₅-S₂₆ and S₂₇-S₂₈.

First level switches S₁₁ . . . S₁₈ determine whether the component is positive or negative, if it is negative then its positive p component terminal will be connected to one of the lower inputs of the filter and the negative n component terminal will be connected to the upper input of that filter. This is implemented by closing the switches of the relevant pair: S₁₂ and S₁₃ for setting −I, S₁₆ and S₁₇ for setting −Q.

If the component is taken as positive, then its positive p component terminal will be connected to one of the upper inputs of the filter and the negative n component terminal will be connected to the lower input of that filter. This is implemented by closing the switches of the relevant pair: S₁₁ and S₁₄ for setting +I, S₁₅ and S₁₈ for setting +Q.

Second level switches S₂₁ . . . S₂₈ determine whether the component is I or Q, if it is I then the upper switch of the second level pair is closed: S₂₁ and S₂₃ or S₂₅ and S₂₇. If the component should be outputted as Q then the lower switch of the second level pair is closed: S₂₂ and S₂₄ or S₂₆ and S₂₈.

It is desired to perform the operation on the discrete signal, however it is possible to perform these operations on the continuous signal in time x(t), instead.

It may be equivalent to perform these operations prior to sampling the signal with A/D.

Thus, rather than using an A/D to sample the continuous signal to a discrete signal and then perform the operation described in Table 1, it is possible to perform the operation on the continuous signal prior to sampling.

This will allow adding the two signals and then sampling one signal, instead of sampling two signals.

Therefore, the input signals in FIG. 23 may be: X_{R}=x_{R}(t) and x_{I}=x_{I}(t).

The A/D, neglecting quantization errors, may be considered as a combination of a sample and hold. A sampler samples the continuous signal in certain points in time

t=n*T, wherein the sampling rate is fₛ=1/T . The hold operation simply provides a DC signal which equals to the signal sampled, x(t=n*T) at the A/D output, during the time period: n*T<t≦n*(T+1).

The resulting discrete signal x[n], has discrete values and wherein n is an integer. Thus, the Shift operation is done at specific time points, changing the discrete signal at x[n]. For this reason, it may be equivalent to shift the signal before the A/D rather than after the A/D.

The shift operation can be done just prior to sampling the signal by the A/D. This will ensure that the signal, which is sampled, was shifted in advance.

Thus, the shift* operation can be implemented using the embodiment of FIG. 23, for continuous signals at its input and with synchronization with the A/D or other sampling mechanism.

It may be possible for the First level switches S₁₁ . . . S₁₈ to be synchronized on one clock CLK1, and the second level switches S₂₁ . . . S₂₈ to be synchronized on another clock CLK2.

These clocks may be inputs or independent clocks, and will update the switches in advance of D, so that the new state of the switches for time t=n*T will be set in time n*T−D, allowing the A/D to sample the shifted signal with the second signal correctly.

In a preferred embodiment, CLK2=CLK1, and all the switches are synchronized by one clock CLK1.

This clock may be connected to an external clock, such as from a chip, which controls the sampling and the additional switches system.

In order to prevent critical-race, or signals shortening, it may be possible to control each switch independently, allowing to first open the closed switch in each pair and only then close the second one if required.

In this case, there may be 16 clocks, or otherwise defined clock inputs, which may be defined as CLKₙₖ for switch Sₙₖ wherein n indicates the level 1 or 2, and k is an integer between 1 to 8.

In one embodiment the Analog Devices' Low voltage 4Ω Quad SPST Switches may be used. This may include: ADG711, ADG712 or ADG713.

Using the technology of ADG713 of Break-Before-Make Switching, shortening of signals may be prevented even without using additional clocks. Other devices with Break-Before-Make or similar switching technologies may be used as well.

Filter means may be used similarly to other embodiments described in this invention and as known in the art. Transformer means may be combined with the filter means.

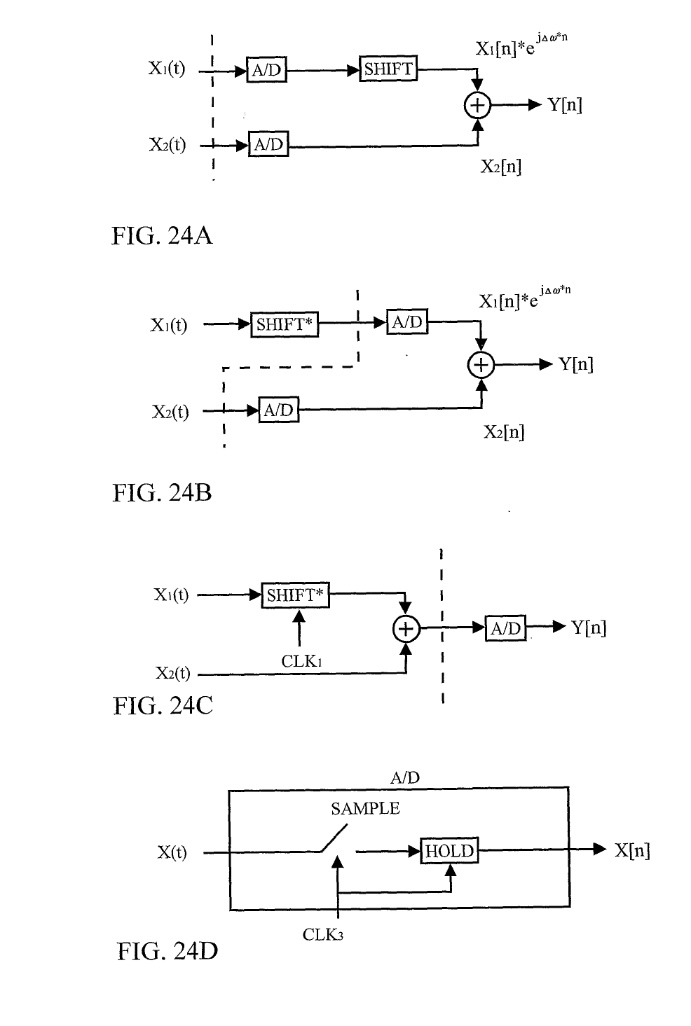

FIGS. 24A-24D detail embodiments for combining two signals on one spectrum. The dashed line separates the analog part on the left versus the digital discrete on the right. It may be desirable to implement as much operations on the left side—thus reducing the requirements from the digital part, which may be limited in resources, and might not support some operations as well.

In particular, such digital operations may be considered difficult or impossible to implement using existing common MAC technology hardware. Even if it possible to implement this, it may require a lot of computing resources which are considered more expensive and limited.

FIG. 24A details a simple embodiment, in which two signals are sampled using A/D, one signal is then shifted such as by multiplying a discrete signal X₁[n] with the complex exponent—for moving the signal to a different non-overlapping frequency range. This embodiment would be mostly digital, consuming much of digital resources.

FIG. 24B details a similar embodiment to that of FIG. 24A, however in this embodiment the shift operation is replaced with analog shift* operation, which is placed before the A/D. This may be implemented such as by using switches as described in this invention, or by using other technologies. The accuracy of the result would nevertheless be the same, about the same, or may be even improved.

FIG. 24C details a similar embodiment to that of FIG. 24B, however in this embodiment the addition operation is implemented using analog means, allowing to use only one A/D rather than two.

This may be implemented for example by using an analog adder, or by using other technologies. The accuracy of the result would nevertheless be the same, about the same, or may even be improved, because there may be smaller quantization error of the A/D. In addition, it may support hardware means, which offer only one A/D for that signal, instead of two.

The shift* operation may be synchronized using a clock signal CLK1, for sampling the signal in the A/D correctly.

FIG. 24D details the structure and method of operation of an A/D. The A/D may be described as having sampling means and hold means. It may be possible to control sampling using a clock signal CLK3. This would allow sampling the signal just after external operations where completed. The A/D can be a part within existing hardware, thus it may be already synchronized with other means and there would only be need to control CLK1.

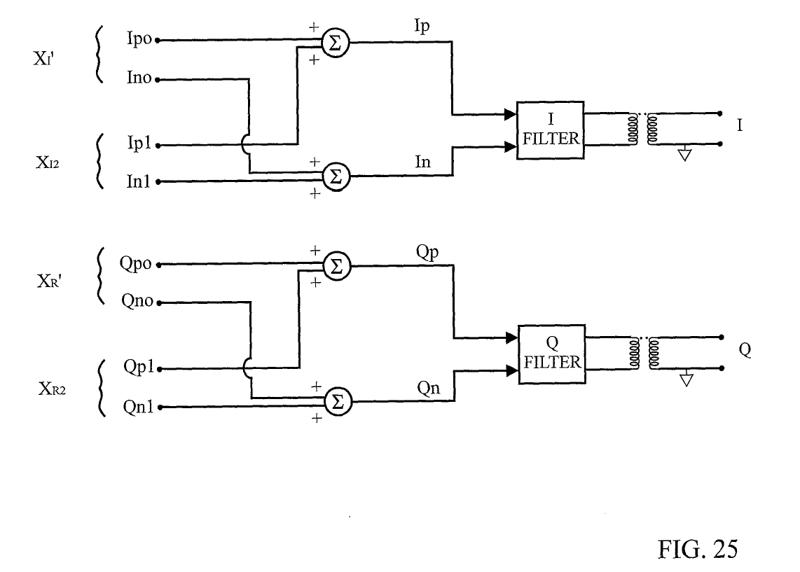

FIG. 25 details a system for combining two signals, each with I and Q.

This embodiment may support adding the I and Q components of two signals, before placement of transformer means, such as by using the system described in FIG. 23, or a system with similar operation, however without using any transformers.

It may be possible to implement a similar system, in which the signals are taken before the filters as well.

Iₚₒ and Iₙₒ are the positive and negative terminals of the Imaginary component of the shifted output signal, respectively. For example, this may be the X_{I}′ signal.

Qₚₒ and Qₙₒ are the positive and negative terminals of the Real component of the shifted output signal, respectively. For example, this may be the X_{R}′ signal.

Iₚ₁ and Iₙ₁, are the positive and negative terminals of the Imaginary component of the second signal, respectively. For example, this may be the X_{I2} signal.

Qₚ₁ and Qₙ₁ are the positive and negative terminals of the Real component of the second output signal, respectively. For example, this may be the X_{R2} signal.

The positive components of the two signals are added and the negative components of the two signals are added, for each component I and Q. This results in new components of I and Q of the sums, which should be sampled, such as after placing I and Q filters and transformers as shown in FIG. 25. Sampling I and Q can be done using A/D's synchronized and placed afterwards (not shown).

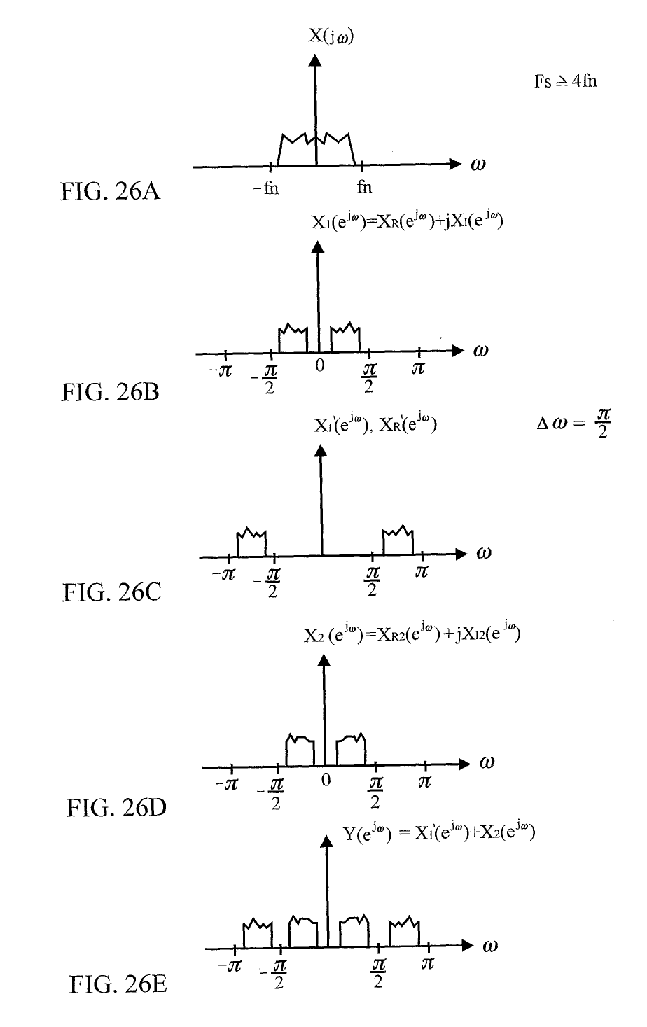

FIGS. 26A-26E detail spectra of signals in the stages of sampling, shifting one signal and summing the signals.

FIG. 26A details the spectra of the first and second continuous signals x_{I}(t) and x₂(t) with a frequency spectrum in the range of −fₙ<f<fₙ.

The continuous signals x_{I}(t) and x₂(t) may be sampled in a rate of: fₛ>4fₙ. It may be required that the real and imaginary components of each of the two signals are found and then sampled.

FIG. 26B details the spectrum of the first discrete signal in frequency domain: X₁(e^{jω}) resulted from sampling the continuous signal.

Because fₛ>4fₙ the signal in frequency domain X₁(e^{jω}) captures up to half of the discrete spectrum, thus each of its components has a spectrum in the range of −π/2<ω<π/2.

FIG. 26C details the spectrum of the first discrete signal shifted in Δω=π/2 [rad/sec].

It may be required to shift the center frequency of one of the signals, to Δω=π/2 so that it will be possible to sum the signals into one spectrum.

It is possible to use embodiments in which two or more Analog to Digital Shifting the frequency of the signal X₁(e^{jω}) to a different radian frequency distanced Δω radians/second higher, which results in a new signal

X₁′(e^{jω})=X_{R}′(e^{jω})+j*X_{I}′(e^{jω}).

FIG. 26D details the spectrum of the second discrete signal in frequency domain: X₂(e^{jω}) resulting from sampling the continuous signal.

Because fₛ>4f_{f} the signal in frequency domain X₂(e^{jω}) captures up to half of the discrete spectrum, each of its components has a spectrum in the range of −π/2<ω<π/2. X₂(e^{jω})=X_{R2}(e^{jω})+j*X_{I2}(e^{jω})

FIG. 26E details the spectrum of the sum of the two signals.

Thus, it is possible to sum the first shifted signal and the second signal:

Y(e^{jω})=X₁′(e^{jω})+X₂(e^{jω}). In practice, it may be required to sum and/or sample the real and imaginary components separately.

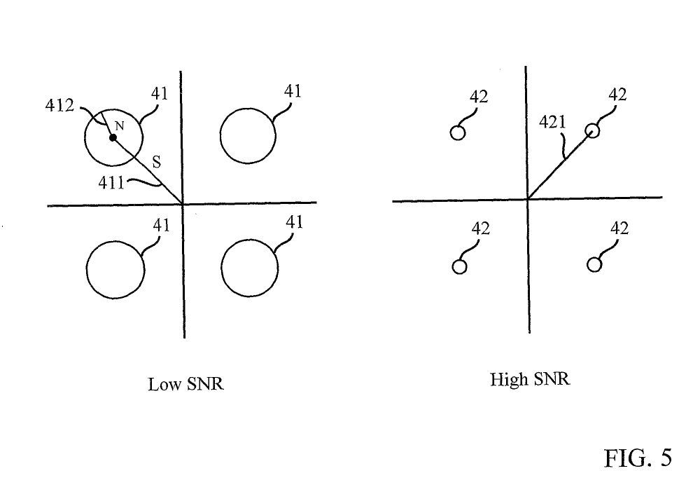

FIG. 5 Details Signal Spaces of two communication channels with Low and High SNRs. In case a Subscriber Station SS receives a signal from a Base Station BS, and the transfer function between the SS and the BS is known, such as by using the known pilot signals within UpLink UL and/or DL DownLink transmissions, better recognition of the signals might be possible, such as using an inverse of h (ĥ−1) or multiplying with its complex conjugate h′ and normalizing.

The purpose is to cancel channel's distortions as much as possible and to find original signals. In a preferred embodiment, after performing the operations mentioned above, a typical constellation of the received signal may appear as either one of the constellations presented. For example, a signal S 411 which should be detected, may include noise N 412, thus possible received signal values may fall within upper left circle 41, or within other possible circles 41, based on the sum of each possible constellation value and noise.

In case the maximum (or effective) noise amplitude 412 is relatively big in relations with the exact constellation's signal amplitude 411, then the reception may considered as having Low SNR, thus it is more difficult to retrieve data from reception.

In case the noise is smaller, the values of the received signal may be within smaller circles 42, and the reception may be considered as having High SNR, thus it is easier to retrieve data from reception.

Similarly if the constellation's signal amplitude 421 is relatively larger than the noise's amplitude, the reception may be considered as having High SNR.

Thus, it may be relatively simple to effectively estimate the SNR of the channel, for future decisions.

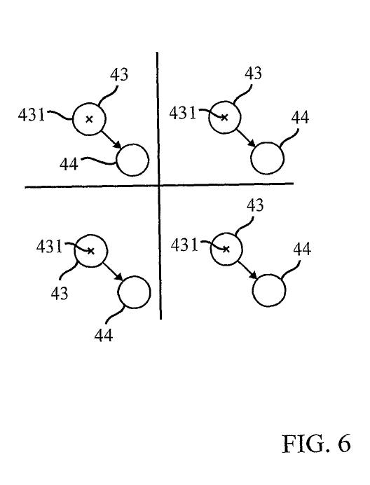

FIG. 6 Details Signal Spaces of communication channels with one or more distortion effects. A similar system to that described in FIG. 5, may be influenced of additional distortions. This may be caused if there are additional signals, which are received at the same time, and especially signals from one or more additional BS's.

Thus, even after some operations are done, a constellation 431, instead of appearing at about circles 43, would appear at about circles 44.

The distortion may be regarded as originating from a BS signal with relatively weaker amplitude. In such a case, the weaker signal would make it harder to recognize the strong signal of a first BS, and in addition the weaker signal may be wasted, such as in case it is treated as noise.

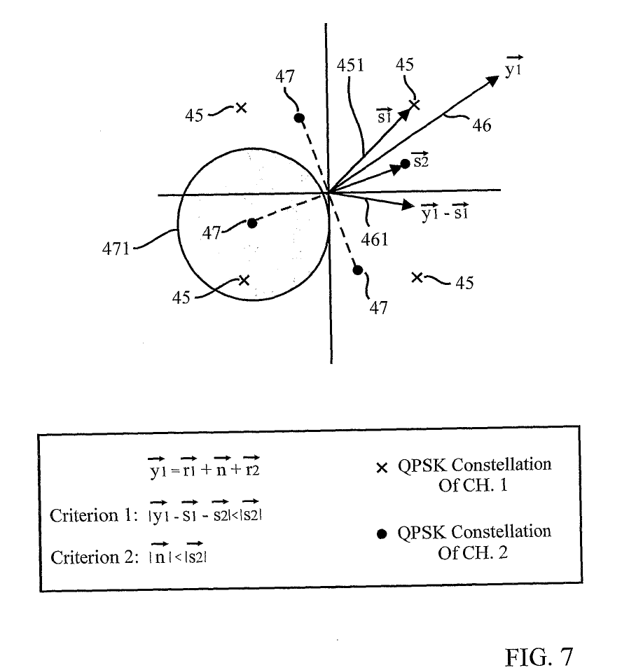

FIG. 7 Details reception of a sum of signals from two channels in Signal Space.

In a preferred embodiment, two signals, such as QPSK constellation signals, are received. The system is adjusted to receive a signal from channel 1, such as with four constellation values 45.

The constellation values of channel 2, may be known as well, for example if the characteristics of h2, the channel between the SS and a BS2, are known.

The constellation values of channel 2, may be four QPSK constellation values 47.

A vector signal y₁ 46 is received. This signal is a sum of two possible constellation values r₁ and r₂, from channel 1 and channel 2, respectively; and noise n.

The vector y₁ is defined in FIG. 7, both mathematically and visually.

A method for identifying the constellation values will now be described, by way of example. It is assumed, and may be known, that the possible constellation values 45, from channel 1, have the biggest amplitude, therefore, it is desired to find the nearest constellation value to received signal y₁ 46.

The selected constellation value, of the four possible values 45, is marked as s₁ 451.

This may preferably be the closest vector to 46, of the possible constellation values 45 of channel 1, or of any possible constellation value in general.

After s₁ is determined, it is subtracted from y₁ and shown by vector 461.

It is then desired to find the nearest constellation value, of the four possible values 47, in order to determine what is the signal originating from channel 2.

In this example, the selected signal is marked as s₂.

Thus, using this new method, both constellation signals are found for the two channels. Rather than treating one of the signals of a BS as noise, data can be retrieved, thus improving performance.

Preferably, this method may be used as it is known, such as based on pilot signals, that a first channel (say channel 1) will be received much stronger than a second channel (say channel 2). Similarly, this method can be implemented for more than two signals of two BS's.

Two criterions will now be described, in order to determine whether it is practical and beneficial, to use the method described.

In a first criterion, described in FIG. 7 as Criterion 1, after s₁ and s₂ are found, they are subtracted from y₁, and the absolute value is compared with that of s₂. If the absolute value of subtraction is smaller than S₂, then this means that the error (or noise) is smaller than the chosen constellation value S₂, and thus this is a reasonable decision. In addition, the likelihood of error may be computed, based on the relation: |y₁−s₁−s₂/|s₂| thus an indication of quality, or c/n (carrier/noise) may be estimated to help decide whether or not to use this method for the signal received.

A second criterion, described in FIG. 7 as Criterion 2, may be used when there are some characteristics of the noise n.

The likelihood of error may be computed, by comparing the average or current absolute value of the noise |n| (or its variance, effective power, etc.) with the absolute value of points 47 (or their average, etc. in cases of other constellations). This absolute value will be marked as |s₂|. In case |n|<|s₂| then it may be beneficial to use the described method, since the noise is weaker than estimated constellation value.

An indication of quality |s₂|/|n| or c/n (carrier/noise) may be estimated, to help decide whether or not to use this method for the signal received.

Another criterion involves measuring and/or calculating |s₁|/|s₂| in order to evaluate whether one signal is much stronger—thus enabling an efficient subtraction.

Area 471 demonstrated an effective area of decision around a constellation value 47, thus if the noise n is stronger than the radius of the circle 471, wrong decision for the signal of channel 2 may occur.

It should be noted that more than one criterion or approaches may be used, in order to obtain a better decision. These criterions may also be used in order to determine NOT to use the described method, and use traditional or other approaches described in this paper.

In cases QPSK is used for both channels, and where s₁ and S₂ are additive, thus when the phase difference between them is smaller than 90 degrees (the maximum is 180 degrees), this method may be extremely beneficial, at least for finding the strong signal.

CRC and/or error correction techniques for digital data values may help to further determine the signals, and better identify signals of several BS's.

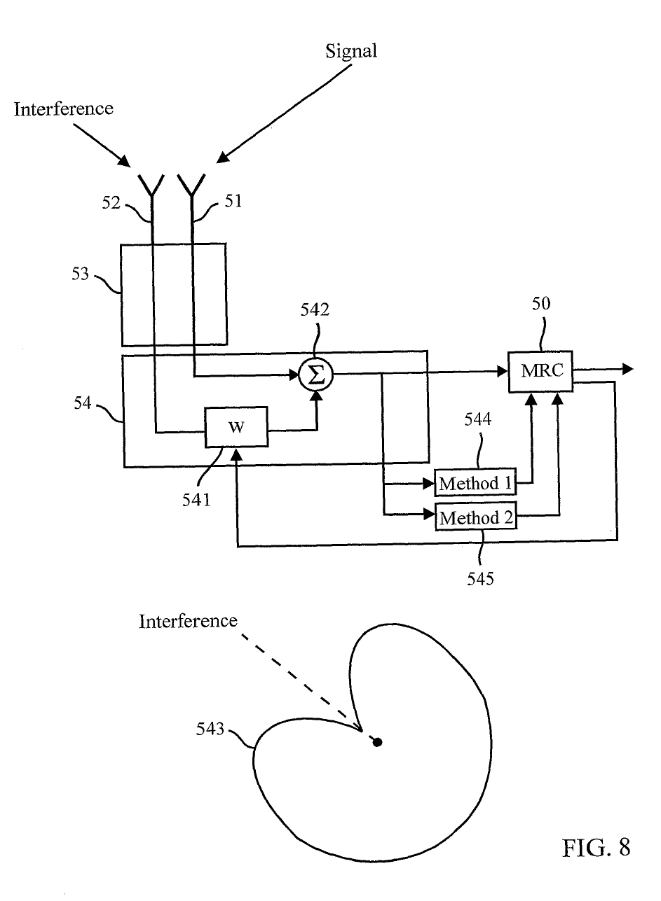

FIG. 8 Details a system with two antennas 51 and 52, for reducing interferences with MRC 50. It may be desired to block or attenuate a signal of a BS, or interferences from a certain direction. This may be implemented using an adjustable antenna pattern 543, which is set to attenuate interferences or undesired signals.

The direction to which the adjustable antenna pattern is pointed to, can be set at a receiver front end 53, or at an additional unit 54, or within any hardware mean.

For example this may be implemented by inputting a signal from the first antenna 52 to an adjustable delay or otherwise controllable transfer function or phase distortion w 541, added 542 to a received signal from the second antenna 51.

The addition 542 can be made either in analog or in digital means.

The result is inserted to a Maximum Ratio Combining MRC 50 mechanism, which may be implemented in software. In addition, results of two or more methods, may be inputted to the MRC mechanism as well.

These methods, such as method 1 544 and method 2 545, may use any technique described in this paper, in order to better receive and identify the signals, and in particular any of the techniques described with respect to FIG. 7.

The MRC can compare the different methods, in order to select the one with best results—such as lower CRC, better SNR, lower noise parameters, where the error is minimal and/or where there is the smaller number of digital errors detected based on digital error correcting and detecting techniques, etc.

In addition, the MRC may control unit 541, in order to adaptively adjust the antenna pattern 543 against the interferences.

This system may be practical in cases where no BS can be identified with required reliability. Thus, even with relatively strong interferences, the system may still function and identify one or more BS's.

This technique may have better results than Maximum Likelihood Detection MLD, as MLD may not always be able to detect a signal, such as when what is regarded as interferences and noise, is stronger than the signal, which should be detected.

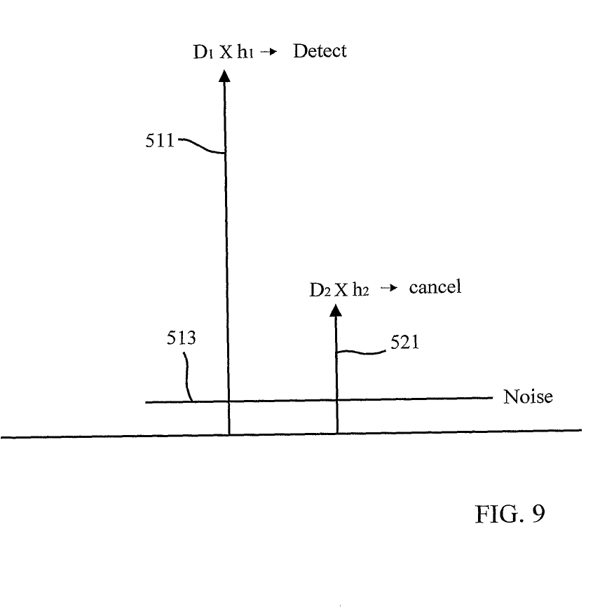

FIG. 9 Details detection of a strong signal with cancellation of a weak signal Although it may be desired to detect a weaker signal, such as signal 521, which may be D₂×h₂ from channel 2, it may be desired to cancel it—for better identification of a relatively strong signal 511, which may be D₁×h₁ from channel 1.

This is done with the presence of noise, with average amplitude (or power, etc.) 513. Since h₁ and h₂ may be known, and when the noise is not strong, it may be easier to detect and effectively separate between the two signals, thus the effect of 521 may be cancelled, and the values of 511 along time may be taken for further error correction.

Techniques described in this paper may be used, to detect the signal of channel h₁ and/or attenuate (or cancel) the signal of h₂. Cancellation may be done by finding the signal of channel 1, by any signal detection method, by maximizing the signal of h₁ by subtracting the signal of h₂, by error detection and correction, etc.

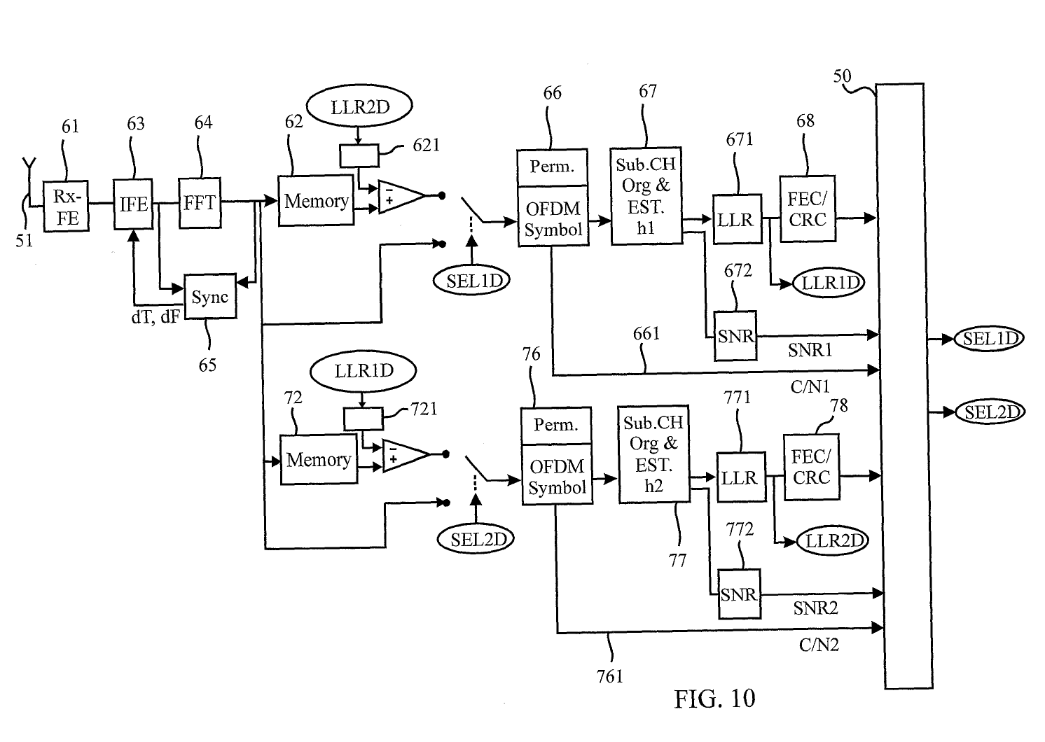

FIG. 10 Details a system for receiving signals from two channels using one FFT 64 mechanism.

One or more antennas 51 with or without directional means such as described in FIG. 8, may be used to receive signals.

Rx Front End 61 may convert the signals to IF. Optionally zero IF, can be implemented and I, Q signals may be set. The signal can be discrete, such as by comprising synchronization means in the Rx Front End.

IFE 63 IF Front End, can be used to help synchronize on the signal, such as using delta time dT and delta frequency dF intervals.

FFT 64 Fast Fourier Transform performed on the signal, converts the symbol from time domain into the frequency domain. The FFT block may implement 1K radix-4 complex FFT. Synchronization mechanism sync 65 may be using frequency and/or time correcting loop for better synchronization.

Record means 62 allow recording the signal and using it afterwards. Preferably the signal is recorded using digital memory means in discrete time and with appropriate synchronization. Analog recording might also be implemented.

In case the recorded signal is taken from the memory 62, it is possible to subtract from it the signal, which was detected for channel 2, using unit 621.

Selector means SEL1D, connects either the received signal, or the abovementioned resulted signal, or the signal from memory, in case unit 621 is not enabled.

Record means 72 may be identical to record means 62, or may be implemented at the same unit together with record means 62, thus these two record means can be implemented using one memory.

Permutations and OFDM symbol block 66 may order the physical location of carriers and perform required multiplications.

Sub-channel organization module, may be included in block 66 and can send data to channel estimator 67 such as slot numbers, symbol numbers, sub channel numbers, selected PN's and information that is received from the UMP DL-UL-MAP parser. Preferably this block works on a frame-by-frame basis.

At the beginning of each frame it may route the preamble data as required. The pilots may be directed without processing and may also be sent to the estimator, such as after being de-rotated by a PN sequence.

Sub Channel Organizing and Establishing 67, based on Channel h₁ may be implemented and adjusted to pilot repetitions and corrections in time. Received symbols may be stored in an OFDM symbol memory. Channel estimation may use the data of carriers stored in that memory, both in time and frequency domains.

The channel estimator at block 67 may invert the channel by using the pilots' data, and then combine the energy of repeated data carriers, if there are such.

The channel estimator may calculate the dF between the FFT symbols, and estimate carrier to noise C/N₁ 661 and interference ratio, for channel 1.

C/N₁ data may be provided from block 66 and/or block 67.

LLR 671 is used to de-map the carriers and generate soft output estimation of bits value from constellation map. The number of LLR values depends on the modulation used for the carrier (2 for QPSK, 4 for 16QAM and 6 for 64QAM, etc.)

LLR values may be sent to a turbo decoder.

The LLR block may use for calculations the channel gain of each carrier.

In addition, the LLR data of channel 1 is routed to LLR1D, in order to allow its subtraction from the channel 2 signal.

SNR 672 calculation may be implemented, such as based on the relation between the desired signal and the noise, or in any other manner, as described. SNR_{I} indication is provided from the SNR block 672. The SNR calculation is implemented as the data is detected, and after channel corrections were made in order to detect the signal of channel 1.

FEC/CRC 68 unit, can perform Forward Error Correction FEC, CRC and/or other operations based on the data, protocol and decoding in order to detect original data, detect and correct errors, etc.

In particular, the FEC/CRC 68 unit may handle bursts, H-ARQ and CRC-16 fields appended at the end of the data block, verify and examine their validity.

Similar step are implemented for the channel 2 signal and will now be described.

Record means 72 allow recording the signal and using it afterwards. Record means 72 may be identical to record means 62, or may be implemented at the same unit together with record means 62, thus these two record means can be implemented using one memory.

Selector means SEL2D, connects either the received signal, or a second signal, in the same manner to that of SEL1D.

In case the recorded signal is taken from the memory 72, it is possible to subtract from it the signal, which was detected for channel 1, using unit 721.

Permutations and OFDM symbol block 76 may order the physical location of carriers and perform required multiplications, similarly to block 66.

Sub Channel Organizing and Establishing 77, based on Channel h₂ may be implemented in a similar manner to that of block 67, except it is adjusted to channel 2, and the parameters of h₂.

The channel 2 estimator may calculate the dF between the FFT symbols, and estimate carrier to noise C/N₂ 761 and interference ratio, for channel 2.

C/N₂ data may be provided from block 76 and/or block 77.

LLR 771 is used for channel 2, in a similar manner to the LLR 671 for channel 1.

The LLR data of channel 2 is routed to LLR2D, in order to allow its subtraction from the channel 1 signal.

SNR 772 calculation for channel 2 may be implemented in a similar manner to that of the SNR 672 for channel 1. SNR₂ indication is provided from the SNR block 772. The SNR calculation is implemented as the data is detected, and after channel corrections were made in order to detect the signal of channel 2.

FEC/CRC unit 78 for channel 2, may be implemented in a similar manner to that of the FEC/CRC unit 68 for channel 1.

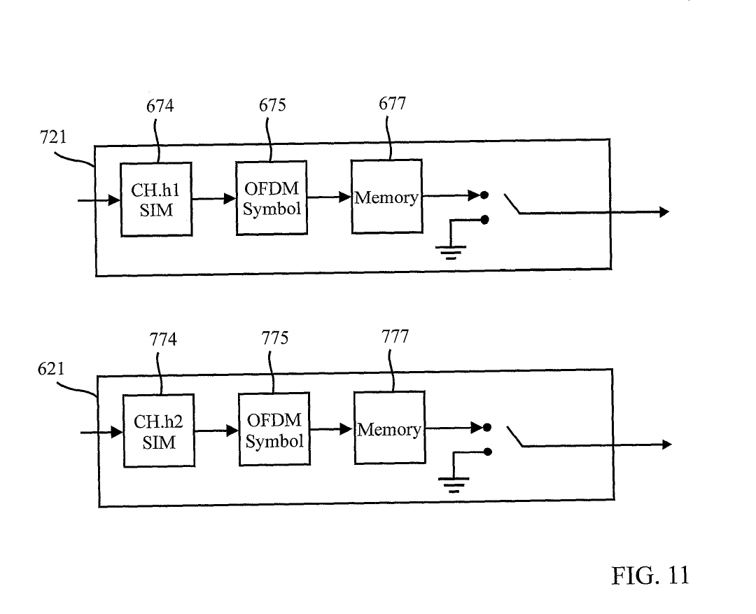

FIG. 11 Details similar Feedback Sub-Systems 621 and 721, used with the system of FIG. 10. Each of the Feedback Sub-Systems 621 and 721, receives the LLR data LLR2D and LLR1D, from the LLR units 771 and 671, of channels 2 and 1, respectively.

These values, upon adjustment, may be subtracted from the signal in memory, in order to cancel and/or reduce the signal of the other channel, thus reduce some of what is considered as noise, but may be in fact the signal from the other channel. This purpose may be demonstrated, as described in FIG. 7, for example.

The order of units 674-677 and 774-777 may be changed, and they may also be placed or used by other means, for example there may already be a mechanism (or software code) for performing some of the mentioned operations.

Each of the Feedback Sub-Systems 621 and 721, may include a channel simulation mechanism 774 and 674 respectively, adjusted for h₂ and h₁, respectively, for restoring the amplitude and/or rotation based on the original signal received.

Optional OFDM Symbol Placement units 775 and 675, for the sub-Systems 621 and 721, are used to further match the signal to be subtracted. Each unit may place relevant OFDM symbols, or perform operations, so as to retrieve the signal originating from relevant channel, which would have been received without noise. Such OFDM data indicative of operations made and OFDM symbols appeared, can be kept in this and/or other units.

Memory units 777 and 677 may keep the signal along time for possible later subtraction. Each of the units 621 and 721, may include a switch at its output, or equivalent means, for determining when to playback the signal from the memory, in order to subtract it, as described in FIG. 10.

The Feedback Sub-System units 621 and 721 may be controlled by a decision unit 50.

The system of FIG. 10, may be operated according to the following method:
1. A signal is received preferably this is a signal which comprises OFDM/OFDMA frames. The signal is received either as RF, IF or Baseband signal; it is synchronized, and passes FFT conversion.
2. The signal and/or relevant parts of the signal are recorded (preferably digital values) and kept in memory means.
3. For each channel, preferably for two channels, relevant data is detected, based on known channel characteristics (such as by using pilots' data, etc.) and by switching the received signals directly and not through memory.
Switching the signals can be managed by unit 50, controlling switches SEL1D and SEL2D.
4. Unit 50, which may include MRC means, or use any algorithm, can take the C/N data, SNR data and also detect errors using FEC/CRC or other error detection/correction means, for deciding what to do next.
5. In case where there is a strong/weak signals model, as described in this paper, it is possible to subtract the detected known signal from the recording, by turning relevant switches, such as SEL1D and providing the known signal using feedback sub-system or equivalent means.
If one of the signals is detected better, such as with high SNR and a small number of errors, it can be subtracted from the second (or other signals) using the subtraction method.
6. Altogether, better detection of signals may be achieved, removing known signals from the received signal, and disregarding them as interferences or noise for other channels.

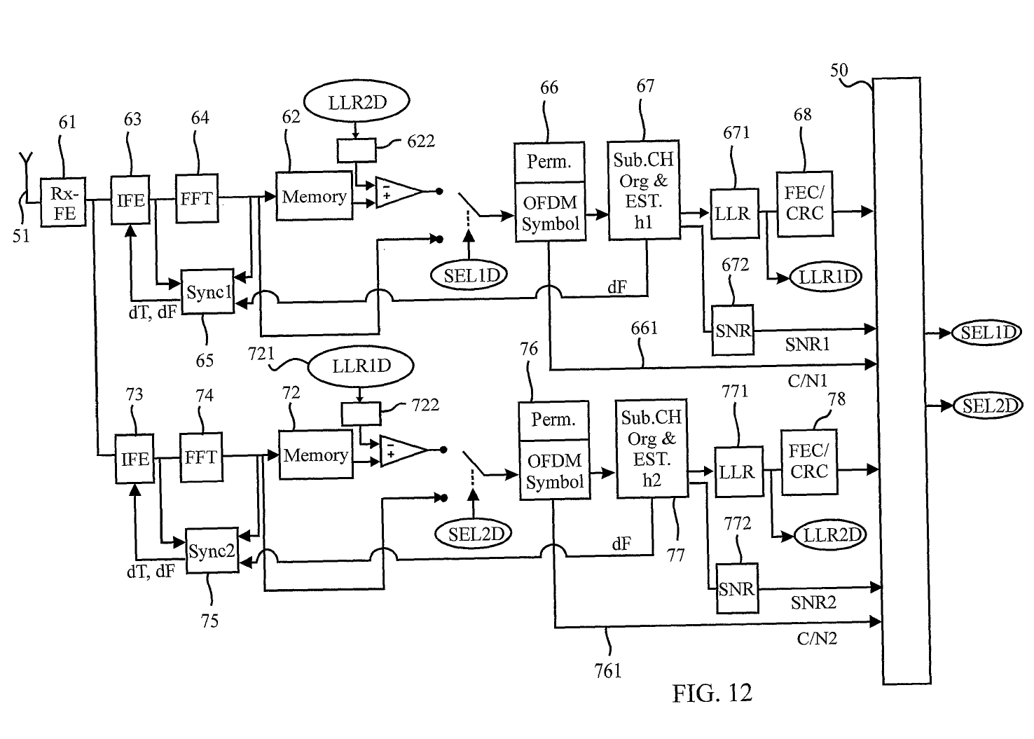

FIG. 12 Details a system for receiving signals from two channels using two FFT mechanisms 64,74. Two antennas or input sources may be used as well, for the two channels.

An additional IFE 73 IF Front End similar to 63, can be used to help synchronize on the signal of the channel, such as using delta time dT and delta frequency dF intervals, which may be synchronized independently for each channel.

FFT 64, 74 Fast Fourier Transform may be performed for channels 1 and 2, respectively. Synchronization mechanisms sync1 65 and sync2 75 may be using frequency and/or time correcting loop for better synchronization for each signal. This may be used with two antennas as well, controlling synchronization in each one.

Permutations and OFDM symbol block 66, 76 may order the physical location of carriers and perform required multiplications. They may improve synchronization for the channel, such as by controlling dF of the relevant sync1 or sync2.

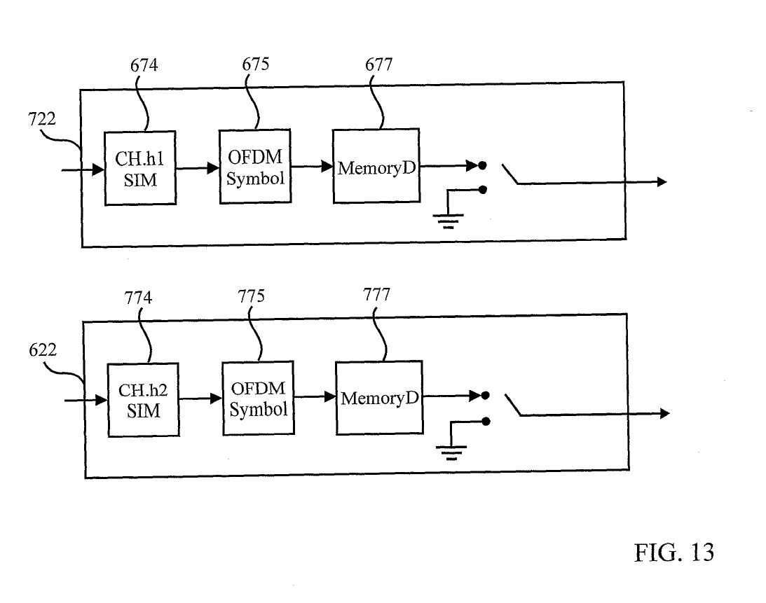

FIG. 13 Details similar Feedback Sub-Systems 622 and 722, used with the system of FIG. 12. The Feedback Sub-Systems 622 and 722, may be identical to Feedback Sub-Systems 621 and 721, respectively.

The order of units 674-677 and 774-777 may be changed, and they may also be placed or used by other means, for example there may already be a mechanism (or software code) for performing some of the abovementioned operations.

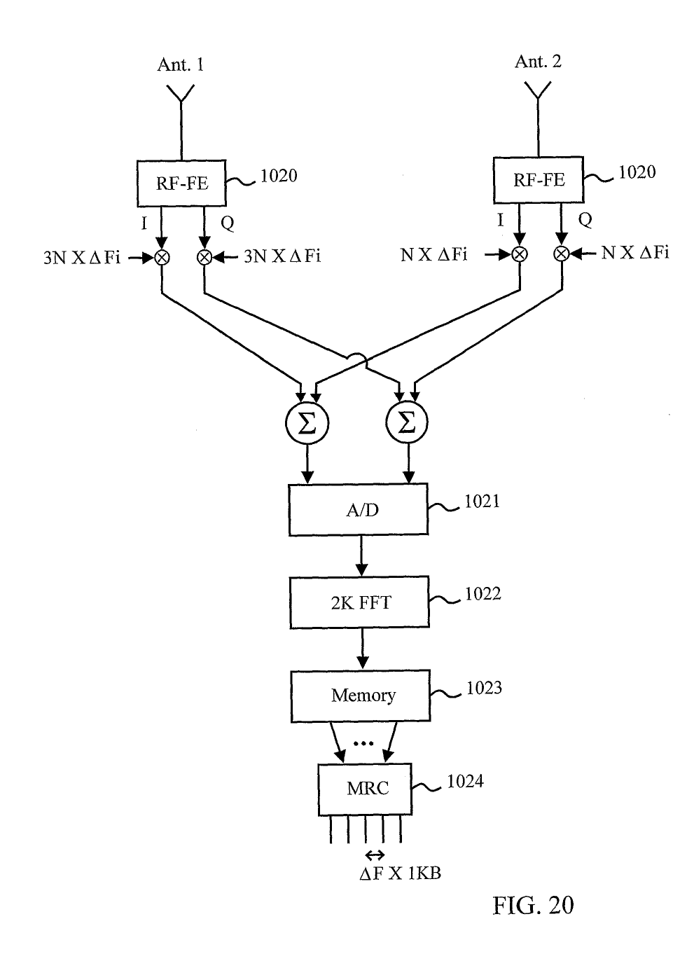

FIGS. 20-22 Detail embodiments for using two antennas and separating I and Q Some systems and/or methods presented in the present application can be used with OFDM and/or OFDMA systems, such as with FFT sizes of 512 to 4096. Such methods and/or systems may use, or be referred as, scalable OFDMA systems and/or methods.

A system for combining two signals to be sampled together is described in FIG. 20.

Two signals may be received at two antennas Ant. 1 and Ant. 2, respectively.

Each of the signals can be converted to IQ signals using Receiver Front End means 1020. In another embodiment, it may also be possible to have two IQ signals, thus units 1020 must not be necessary.

Each of the four I and Q signals, is preferably a baseband, zero IF, signal.

In a preferred embodiment for OFDMA systems the sub channel spacing is ΔFᵢ and the highest frequency of each baseband signal is N×ΔFᵢ.

In one embodiment, the I and Q components of the first signal from Ant. 1, are multiplied with 3N×ΔFᵢ. The I and Q components of the second signal from Ant. 2, are multiplied with N×ΔFᵢ.

The I components are then summed, and the Q components are summed as well. Thus, a new signal containing both I components, and a new signal containing both Q components are formed.

For example, N may be 512, thus it is required to sample two OFDMA signals with N=512 for each of them.

Using one or two A/D's 1021 and double sized FFT 1022, it is possible to sample the new I and Q components, using one hardware, memory 1023, etc and then perform next operations, such as MRC 1024 on all data directly, instead of having separate hardware means for each signal.

It may be possible to sample both I and Q components, wherein each has N=1024, using one 2K FFT (N=2048).

These implementations may be especially useful for using only one chip or processor, rather than two or more.

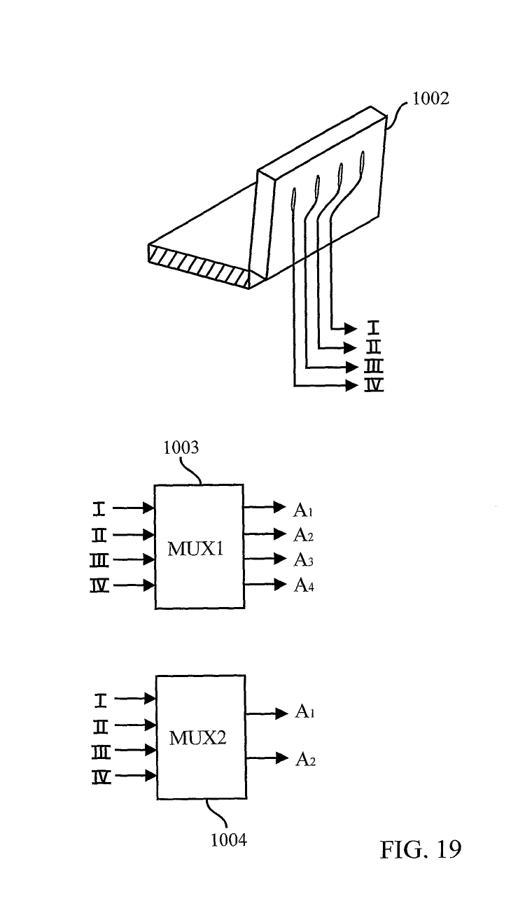

It may also be possible to sample four antennas as well, using similar techniques, or other methods, such as using the system described in FIG. 19.

Thus, double sized FFT 1022, fourth times bigger FFT, or 8-times bigger FFT, can be used so as to sample several antennas and/or both I and Q, more efficiently.

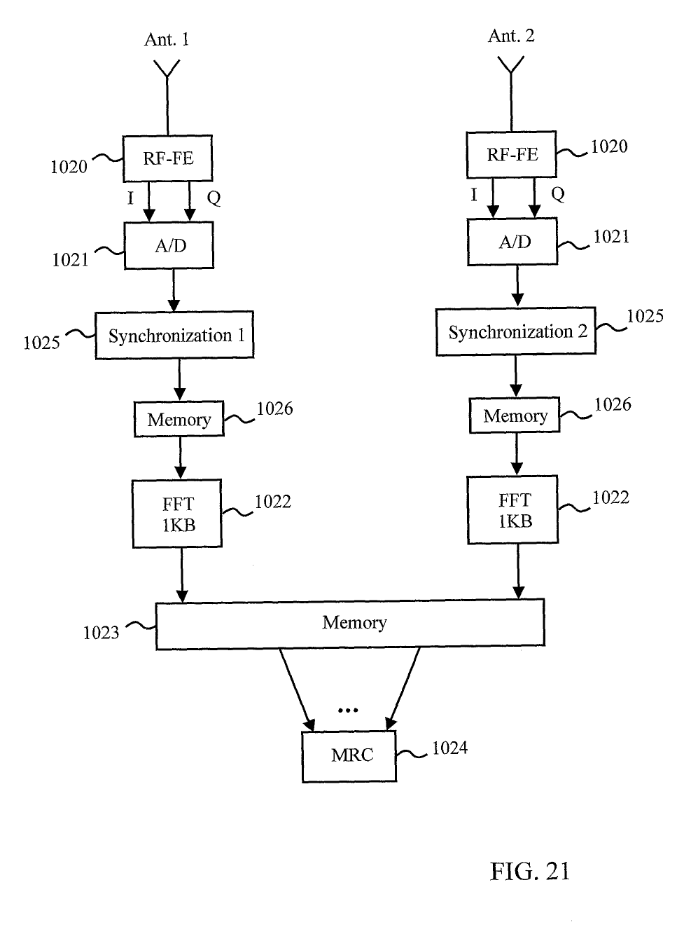

A system for combining two signals to be sampled separately is described in FIG. 21.

Two signals may be received at two antennas Ant. 1 and Ant. 2, respectively.

Each of the signals can be converted to IQ signals using Receiver Front End means 1020, have a separate A/D converter 1021, and a synchronization mechanism 1025 and 1024, respectively.

The data of each antenna may be kept in different memory 1026, sampled by an individual FFT 1022, for 1 and Q together or for each of them separately, and the result can be combined in one memory 1023—for future operations, such as MRC 1024.

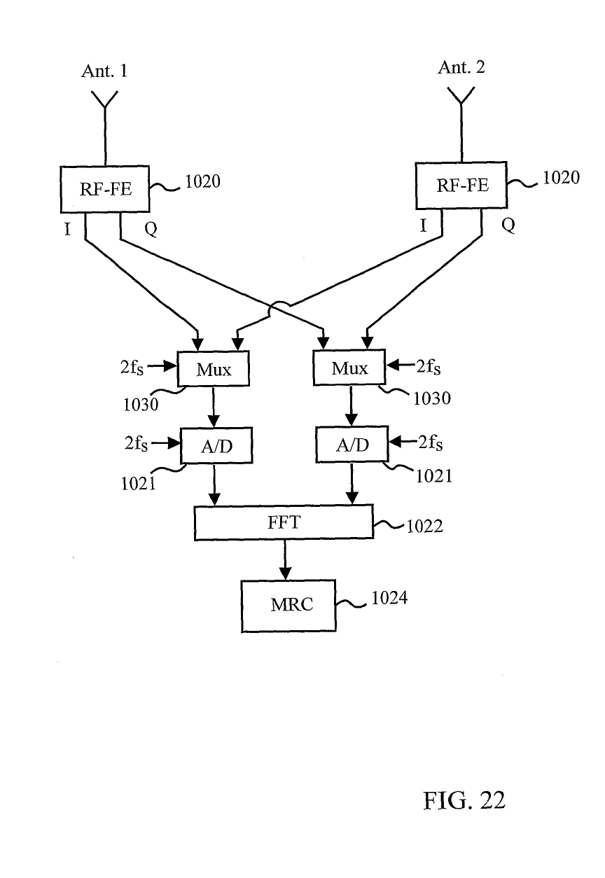

A system for combining two signals to be sampled separately is described in FIG. 22.

Two signals may be received at two antennas Ant. 1 and Ant. 2, respectively.

Each of the signals can be converted to IQ signals using Receiver Front End means 1020. It is then possible using Mux 1030 at a doubled sampling rate 2×Fₛ to sample the signals and then use only one FFT 1022, possibly using a system and/or method as detailed elsewhere in the present application.

The present disclosure is but one example of system and method embodiments for implementing the present invention, and that various modification will occur to persons skilled in the art upon reading the present disclosure and the related drawings.

1. In a cellular wireless system with interference originating from one or more adjacent base stations, a system for reducing the interference comprising:
a. in the SS, means for identifying and/or canceling the signals of one or more of k BSs, within a finite number of time steps and/or intervals and/or frames;
b. at each BS, means for repeatedly sending the same data k+1 times, coded with a biphase code and synchronized in time, to allow to constructively combine the transmissions from a desired BS while destructively combining the transmissions from the other BSs, to reduce the interference from the undesired BSs.

2. The cellular wireless system according to claim 1, wherein there are known pilot signals within each UL and/or DL transmission, these pilots allow learning about the transfer function h or Channel Impulse Response of the channel at about that time, thus better recognition of the signals might be possible, such as using an inverse of h(ĥ−1) or multiplying with its complex conjugate h′ and normalizing, to cancel or reduce a channel's distortions as much as possible and to restore the original signal.

3. The cellular wireless system according to claim 1, wherein the pilots are not known or do not change much in time and/or frequency and/or between intervals, then using the fact or assumption that the channel's behavior did not change too much, to cancel or reduce the effect of other BSs.

4. The cellular wireless system according to claim 1, wherein using the pilots of each BS which are unique at a preamble section of a frame per standard 802.16, to reduce interference from adjacent BSs.

5. The cellular wireless system according to claim 1, wherein using the system in Orthogonal Frequency Division Multiplexing (OFDM) or Orthogonal Frequency Division Multiple Access (OFDMA) compatible systems, with LOS Line Of Sight, or for NLOS Non Line Of Sight systems.

6. The cellular wireless system according to claim 1, for reducing interference from one adjacent BS, wherein directing one of the BSs to repeat its same data transmissions with the same polarity and the other BS to repeat its same data transmissions with an alternating polarity, then adding the repeat signals at the SS either in phase or at an alternately reversed polarity, to tune to either one of the BS transmissions as desired.

7. The cellular wireless system according to claim 1, further including means for reliably detecting the signals of the BS which is received at a higher power, then subtracting a reconstructed signal of the detected signal from the received signal, then detecting the signals from the other BS.

8. The cellular wireless system according to claim 1, further using pilot signals for learning the transfer function h of the channel at that time, to achieve a better recognition of the signals and/or to reduce a channel's distortions.

9. The cellular wireless system according to claim 8, wherein the pilot signals of each BS are at unique frequencies at a preamble section of a frame.

10. The cellular wireless system according to claim 1, wherein using two or more antennas at a mobile station (MS), to find the direction of the signal of interest and cancel or attenuate other signals, receive more data and/or use a larger bandwidth, using wider protocols and/or using other types of OFDMA signals.

11. In a cellular wireless system, a method for transmitting signals from a first base station (BS) to a subscriber station (SS), while reducing interference from adjacent BSs, comprising:
A. Setting each BS to transmit its same data k+1 times, possibly as a negative signal some of the times, wherein k is the number of BSs which should be canceled, data is transmitted in the same frame and/or time and frequency area by two or more BSs;
B. Each BS transmits Pilots or other indicative signals at the beginning of a frame or other time interval, allowing to find or gather information about the behavior of the communication channel between each BS and the SS;
C. Performing a synchronization of signals and frames between BSs so that the signals would be orthogonal with possibly higher PG, and the pilots of each BS will not interfere the others pilots at an initial time of the frame or interval;
D. Programming the other BSs in conjunction with the data of BS 1 intended to the SS, are programmed, to transmit their data in a manner which would allow to cancel the other BSs data when the signals received by the SS is normalized and combined with the signals of BS1;
E. Receiving the data by a SS, which knows or being told how to cancel neighbor or other BSs;
F. Performing mathematical operations identical or equivalent to canceling or reducing the signals of other BSs. Using the k+1 equations it may be possible to cancel other k BSs, remaining with the desired data of BS1;
G. Performing the above activities at other BSs, to allow each BS to better use its resources and still not interfere too much other BSs using the same resources;
H. Finding new transfer functions of the channel, h˜, to cancel or reduce the signals of other BSs, while Summing up coherently the signals of BS1 in different time intervals and/or frames.

12. The cellular wireless method according to claim 11, wherein there are known pilot signals within each UL and/or DL transmission, these pilots allow learning about the transfer function h or Channel Impulse Response of the channel at about that time, thus better recognition of the signals might be possible, such as using an inverse of h (ĥ−1) or multiplying with its complex conjugate h′ and normalizing, to cancel or reduce a channel's distortions as much as possible and to restore the original signal.

13. The cellular wireless method according to claim 11, wherein the pilots are not known or do not change much in time and/or frequency and/or between intervals, then using the fact or assumption that the channel's behavior did not change too much, to cancel or reduce the effect of other BSs.

14. The cellular wireless method according to claim 11, wherein using the pilots of each BS which are unique at a preamble section of a frame per standard 802.16, to reduce interference from adjacent BSs.

15. The cellular wireless method according to claim 11, wherein using the system in Orthogonal Frequency Division Multiplexing (OFDM) or Orthogonal Frequency Division Multiple Access (OFDMA) compatible systems, with LOS Line Of Sight, or for NLOS Non Line Of Sight systems.

16. The cellular wireless method according to claim 11, for reducing interference from one adjacent BS, wherein directing one of the BSs to repeat its same data transmissions with the same polarity and the other BS to repeat its same data transmissions with an alternating polarity, then adding the repeat signals at the SS either in phase or at an alternately reversed polarity, to tune to either one of the BS transmissions as desired.

17. The cellular wireless method according to claim 11, further including means for reliably detecting the signals of the BS which is received at a higher power, then subtracting a reconstructed signal of the detected signal from the received signal, then detecting the signals from the other BS.

18. The cellular wireless method according to claim 11, further using pilot signals for learning the transfer function h of the channel at that time, to achieve a better recognition of the signals and/or to reduce a channel's distortions.

19. The cellular wireless method according to claim 18, wherein the pilot signals of each BS are at unique frequencies at a preamble section of a frame.

20. The cellular wireless method according to claim 11, wherein using two or more antennas at a mobile station (MS), to find the direction of the signal of interest and cancel or attenuate other signals, receive more data and/or use a larger bandwidth, using wider protocols and/or using other types of OFDMA signals.

21. In a cellular wireless system, a method for transmitting signals from a first base station (BS) to a subscriber station (SS), while reducing interference from adjacent BSs, comprising:
A. Allowing no change over time, so as to assume that the transfer function h for relevant channels does not change too much in time;
B. Keeping constant the data transmitted from relevant BSs, or transmitting the opposite/negative signals, whilst keeping the BSs in synchronization with each other;
C. Finding the data of each BS, by combining the received signals correctly.

22. The cellular wireless method according to claim 21, wherein there are known pilot signals within each UL and/or DL transmission, these pilots allow learning about the transfer function h or Channel Impulse Response of the channel at about that time, thus better recognition of the signals might be possible, such as using an inverse of h(ĥ−1) or multiplying with its complex conjugate h′ and normalizing, to cancel or reduce a channel's distortions as much as possible and to restore the original signal.

23. The cellular wireless method according to claim 21, wherein the pilots are not known or do not change much in time and/or frequency and/or between intervals, then using the fact or assumption that the channel's behavior did not change too much, to cancel or reduce the effect of other BSs.

24. The cellular wireless method according to claim 21, wherein using the pilots of each BS which are unique at a preamble section of a frame per standard 802.16, to reduce interference from adjacent BSs.

25. The cellular wireless method according to claim 21, wherein using the system in Orthogonal Frequency Division Multiplexing (OFDM) or Orthogonal Frequency Division Multiple Access (OFDMA) compatible systems, with LOS Line Of Sight, or for NLOS Non Line Of Sight systems.

26. The cellular wireless method according to claim 21, for reducing interference from one adjacent BS, wherein directing one of the BSs to repeat its same data transmissions with the same polarity and the other BS to repeat its same data transmissions with an alternating polarity, then adding the repeat signals at the SS either in phase or at an alternately reversed polarity, to tune to either one of the BS transmissions as desired.

27. The cellular wireless method according to claim 21, further including means for reliably detecting the signals of the BS which is received at a higher power, then subtracting a reconstructed signal of the detected signal from the received signal, then detecting the signals from the other BS1.

28. The cellular wireless method according to claim 21, further using pilot signals for learning the transfer function h of the channel at that time, to achieve a better recognition of the signals and/or to reduce a channel's distortions.

29. The cellular wireless method according to claim 28, wherein the pilot signals of each BS are at unique frequencies at a preamble section of a frame.

30. The cellular wireless method according to claim 21, wherein using two or more antennas at a mobile station (MS), to find the direction of the signal of interest and cancel or attenuate other signals, receive more data and/or use a larger bandwidth, using wider protocols and/or using other types of OFDMA signals.
